(19) United States
(12) Patent Application Publication
(10) Pub. No.: US 2004/0078257 A1
(43) Pub. Date: Apr. 22, 2004

(54) Labor and resource scheduling system

(75) Inventors: George H. Schweitzer, Camas, WA (US); Bryan R. Elder, Oak Harbor, WA (US)

Correspondence Address: KLARQUIST SPARKMAN, LLP, 121 SW SALMON STREET, SUITE 1600, PORTLAND, OR, 97204, US

(73) Assignee: LaborSage, Inc.

(21) Appl. No.: 10/367,443

(22) Filed: Feb. 14, 2003

Related U.S. Application Data
(60) Provisional application No. 60/420,378, filed on Oct. 21, 2002.

(51) Int. Cl. G06F 17/60

(52) U.S. Cl. 705/9

(57) ABSTRACT

An automated labor and resource scheduling system provides automated assistance to scheduling managers for scheduling labor and resources to host and service events at a facility. The automated scheduling is based on on real time and motion analysis, resulting in realistic and clearly defined productivity expectations. It assists management in minimizing labor costs for events of any size, while providing greater confidence that proper staffing guidelines are in place to cover all bases. The automated scheduling helps eliminate guess work involved in manual scheduling, and more readily identifies near optimum labor margins. The scheduling system also provides employees itineraries with clear expectations, along with a map which charts the flow of events, resulting in improved performance, labor expense savings, and enhanced communication in the scheduling process.

### TECHNICAL FIELD

The present invention relates to labor and resource scheduling, and more particularly relates to scheduling to provide more efficient utilization of labor and resources in event management and other fields.

### BACKGROUND

A large variety of events are hosted and serviced at hotels, conference centers, exposition halls, and like event-management facilities. The labor and resources required for the events can differ greatly due to the variety of events and variations between facilities. For example, the labor and resource requirements for a luncheon or dinner banquet can differ significantly from those for a lecture, wedding reception, exhibition, etc. Further, variations in facilities create different demands for labor and resources to host or service events.

Labor schedules for events are currently developed on a manual basis throughout the world. The task of scheduling is a difficult exercise which requires event managers to sift through countless banquet event contracts on a weekly basis, in an attempt to cover all staffing requirements necessary to handle events. Effectiveness in labor planning is highly dependent upon the education and capability of each event manager. Unfortunately, the complexity and time required to cover all aspects of booked events is often a staggering task which, due to human nature, results in inefficiencies and excessive labor costs.

### SUMMARY

Implementations described herein of a labor and resource scheduling system more effectively schedules labor to make efficient use of labor and resources, so as to avoid excess labor costs. The described labor and resource scheduling system performs more efficient scheduling for widely varying event requirements and facilities based on facility-specific time analysis of task assignments. More particularly, a time and distance analysis is made of a specific facility and resources. For example, the times to transport resources between storage areas and various “sellable” rooms of a facility and times to perform various other tasks at the facility. For example, the time for various assignments, such as setting up an 8′ table in a banquet configuration in a particular meeting room of a facility, is measured to take into account times for travel or unique setup/task requirements from room to room, storage areas, or any sellable area within an event facility. Timings for preparation, preparation for transport, transporting, setup, teardown, cleaning and storage of all resources are determined and customized, as necessary, at each facility utilizing the system. Resource packages also are customized on a facility specific basis, to allow for multiple resource timings, as outlined above. The labor and resource scheduling system is thus informed of facility-specific labor requirements for various task assignments that compose various events that can be hosted at a facility, and can more efficiently schedule labor and resources for the events to fulfill these task assignments while avoiding excess labor.

The system further ensures users enhanced communication, improved customer service and optimum productivity. The system produces employee schedules based on real time and motion analysis, resulting in realistic and clearly defined productivity expectations. The system is designed to be an automated scheduling tool which positively impacts communication, customer service, and productivity. It assists management in minimizing labor costs for events of any size, while providing greater confidence that proper staffing guidelines are in place to cover all bases.

The labor and resource scheduling system appeals to all facility managers because it provides employees itineraries with clear expectations, along with a map which charts the flow of events, resulting in improved performance and dramatic savings in labor expense compared to prior manual techniques. Moreover, it provides management the capability to accurately audit employee productivity, a task which heretofore has proven to be too time consuming, if not overwhelming, for the best of managers. Typically, upper management has relied upon estimates of “acceptable labor margins” as a threshold for measuring success. Facility Managers which use the system can eliminate the guess work and be able to readily identify near optimum labor margins. They also experience improved customer service, due to enhanced communication in the scheduling process. Employees will quickly know what functions they're assigned to, where to go, what tasks to perform, and how long the tasks take to perform without the need for immediate directives from a supervisor.

Additional features and advantages of the invention will be made apparent from the following detailed description of embodiments that proceeds with reference to the accompanying drawings.

### BRIEF DESCRIPTION OF THE DRAWINGS

FIG. 1 is a flow diagram of basic processes performed by the event labor and resource scheduling system, such as on a daily basis to formulate and maintain schedules.

FIG. 2 is a dataflow diagram illustrating import of Banquet Event Order (BEO) information from an event booking system into the labor and resource scheduling system.

FIG. 3 is a flow diagram of a process to create labor and resource scheduling in the labor and resource scheduling system.

FIG. 4 is a flow diagram of a process to create tasks and resources in the labor and resource scheduling system.

FIG. 5 is a flow diagram of an assignment generation process to create task assignments in the labor and resource scheduling system.

FIG. 6 is a flow diagram of an assignment generation process to create resource assignments in the labor and resource scheduling system.

FIGS. 7, 8, 9 and 10 are flow diagrams of an automated scheduling process to schedule shifts and allocate assignments in the labor and resource scheduling system.

FIG. 11 is a diagram of a screen display presented by the labor and resource scheduling system for schedule maintenance.

FIG. 12 is a diagram of a screen display presented by the labor and resource scheduling system for defining a room definition.

FIG. 13 is a diagram of a screen display presented by the labor and resource scheduling system for defining a room definition.

FIG. 14 is a diagram of a room data collection report produced from data in the labor and resource scheduling system.

FIG. 15 is a diagram of a screen display presented by the labor and resource scheduling system for defining resource definitions.

FIG. 16 is a diagram of a screen display presented by the labor and resource scheduling system for defining resource definitions.

FIG. 17 is a diagram of a resource data collection report produced from data in the labor and resource scheduling system.

FIG. 18 is a diagram of a screen display presented by the labor and resource scheduling system for defining task definitions.

FIG. 19 is a diagram of a screen display presented by the labor and resource scheduling system for defining task definitions.

FIG. 20 is a diagram of a screen display presented by the labor and resource scheduling system for defining employee definitions.

FIG. 21 is a diagram of a screen display presented by the labor and resource scheduling system for defining employee definitions.

FIG. 22 is a diagram of a screen display presented by the labor and resource scheduling system for scheduling labor.

FIG. 23 is a diagram of a screen display presented by the labor and resource scheduling system for scheduling labor.

FIG. 24 is a block diagram of a suitable computing environment for the labor and resource scheduling system.

FIG. 25 is a diagram of a printable report produced by the labor and resource scheduling system and representing events occurring during the scheduled week.

FIG. 26 is a diagram of a printable report produced by the labor and resource scheduling system and representing employee shift times during the scheduled week.

FIG. 27 is a diagram of a printable report produced by the labor and resource scheduling system and representing employee duties during a shift.

FIG. 28 is a diagram of a printable report produced by the labor and resource scheduling system and representing efficiency in scheduling during the scheduled week.

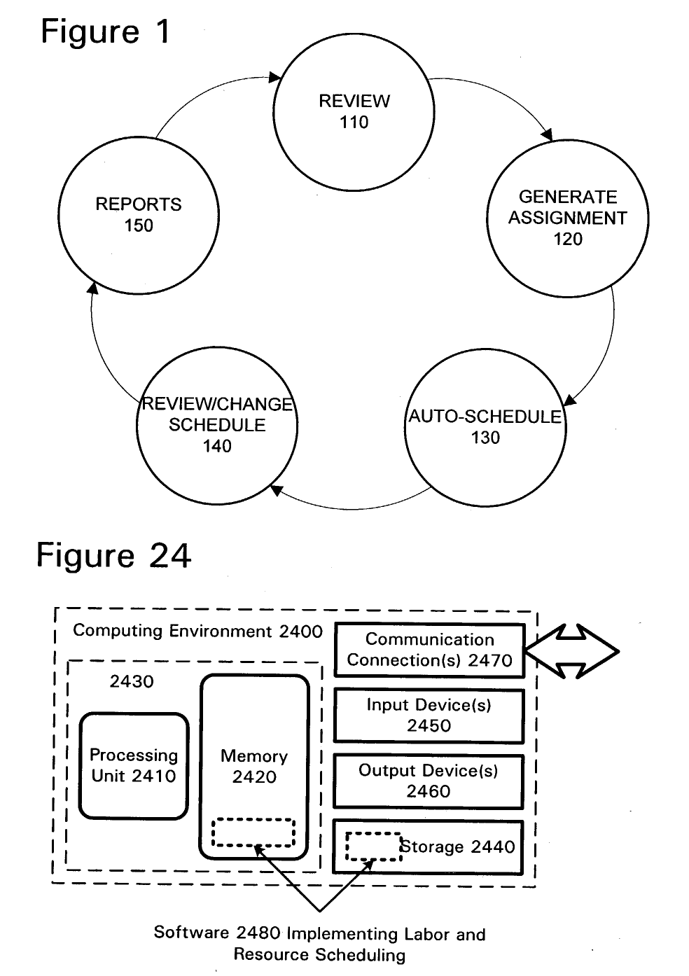

### DETAILED DESCRIPTION

### Introduction

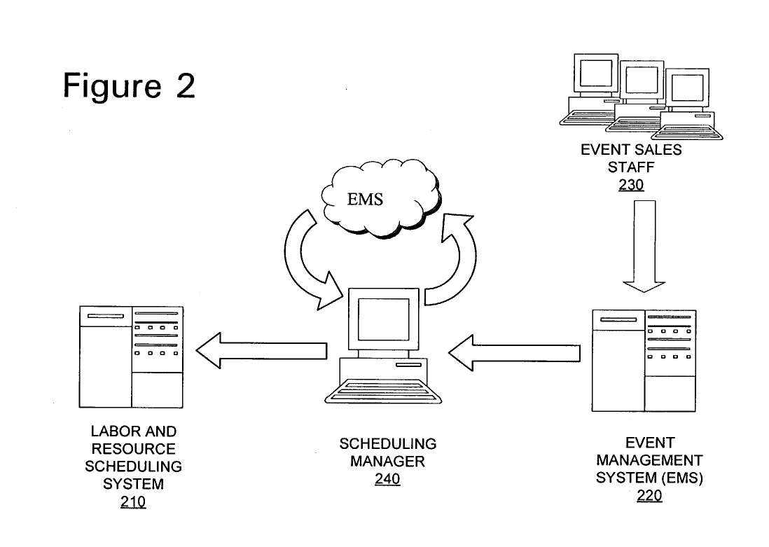

The following description is directed to techniques for labor and resource scheduling based on time and distance analysis data for a subject facility. In one illustrated implementation, the techniques are incorporated into a Labor and Resource Scheduling System 210 (FIG. 2) for event management. The labor and resource scheduling described herein alternatively can be incorporated into labor and resource scheduling systems for other types of facilities and other fields than events. For example, the labor and resource scheduling described herein alternatively can be applied to scheduling labor and resources in laundry, food preparation, and other work places and fields.

The following description of the illustrated labor and resource scheduling system proceeds through the definition of:

Vision and scope

Workflow diagram, and

Functional specification.

Vision and Scope

With reference to FIG. 2, the labor and resource scheduling system 210 provides the ability to use computer technology to automatically schedule labor for events, using real time and motion analysis, along with “Event Mapping” methodology, taking into consideration past/current/future event setup requirements prior to assigning shifts and responsibilities to employees.

The system has been designed as “add-on” software, with an import feature which reads Banquet Event Order (BEO) information output data exported from commercial event booking systems (Event Management Systems or EMS) 220. In alternative implementations, event information can be imported in other formats. In still other implementations, the labor and resource scheduling system and event management system can be integrated as a single system, which can execute on a stand-alone computer, or a client/server or other distributed computing system. Essentially, the labor and resource scheduling system recognizes information pertinent to the theme, style, setup and service requirements for all booked events. The system can also be used as a “stand-alone” product, allowing manual entry of all BEO information. Once the data has been entered, additions or modification of specific details/requirements can be made via point and click, keyboard entries or other user editing inputs. After all event specific information has been entered, whether through manual input or importation, the system will generate assignments to appropriately setup, service and teardown all events. Such assignments can then be automatically assigned to employees, either by the system or user, dependent upon user preference.

The labor and resource scheduling system 210 for events includes, but is not be limited to, the following features:

1) An employee HRIS system (Human Resource Information System), which tracks basic employment information, as well as performance, availability, shift preferences, capability, roles, and lifting ability. The HRIS system will allow customization and weighting of facility specific labor rules to assist in selection of employees for automated scheduling.

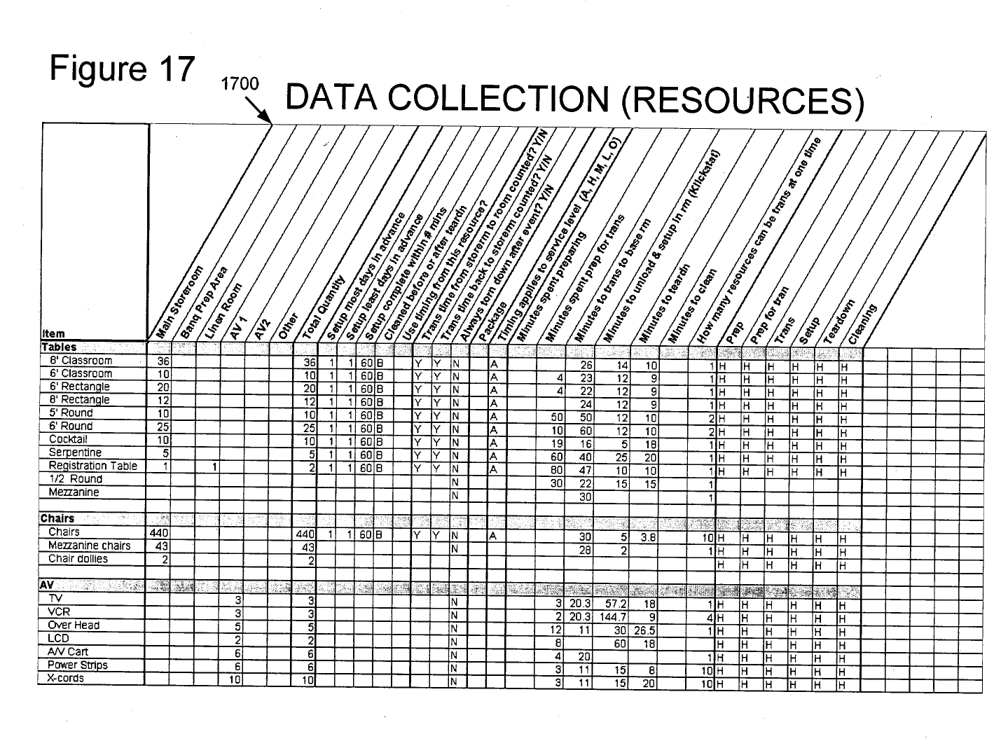

2) An inventory database (illustrated in resources data collection worksheet 1700 in FIG. 17, for example), wherein all resources and their corresponding capacities will be inventoried and maintained. Resource availability will also be tracked. Timings for preparation, preparation for transport, transporting, setup, teardown, cleaning and storage of all resources for different service levels, if needed, will be determined and customized, as necessary, at each facility utilizing the system. Resource packages will also be customized on a facility specific basis, to allow for multiple resource timings, as outlined above.

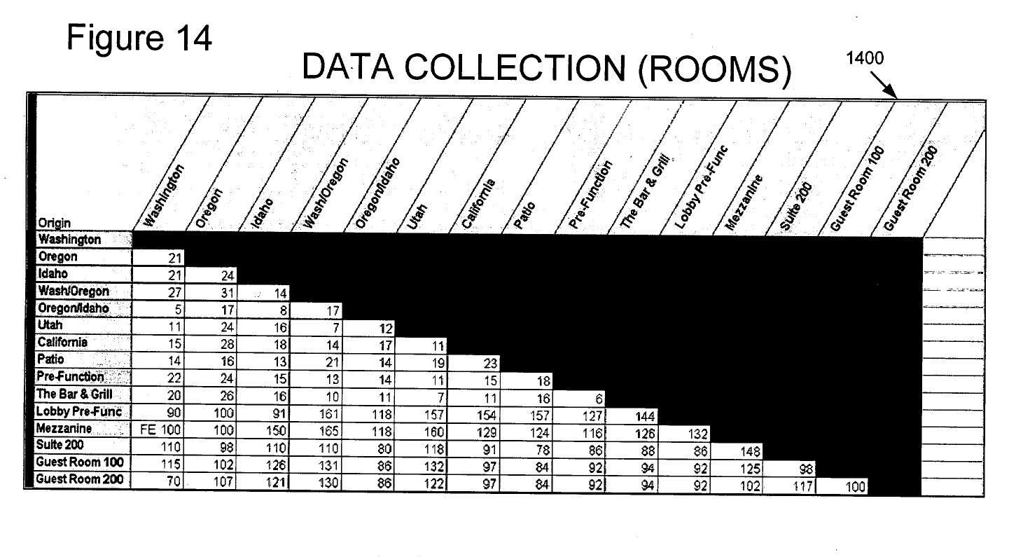

3) Room inventory/feature recognition, wherein times for travel or unique setup/task requirements from room to room, storage areas, or any sellable area within an event facility, are acknowledged and tracked, ensuring accurate and reasonable time allowances for completion of tasks (as represented in rooms data collection worksheet 1400 in FIG. 14, for example).

4) The ability to add or modify tasks to meet requirements for facility specific jobs and service standards.

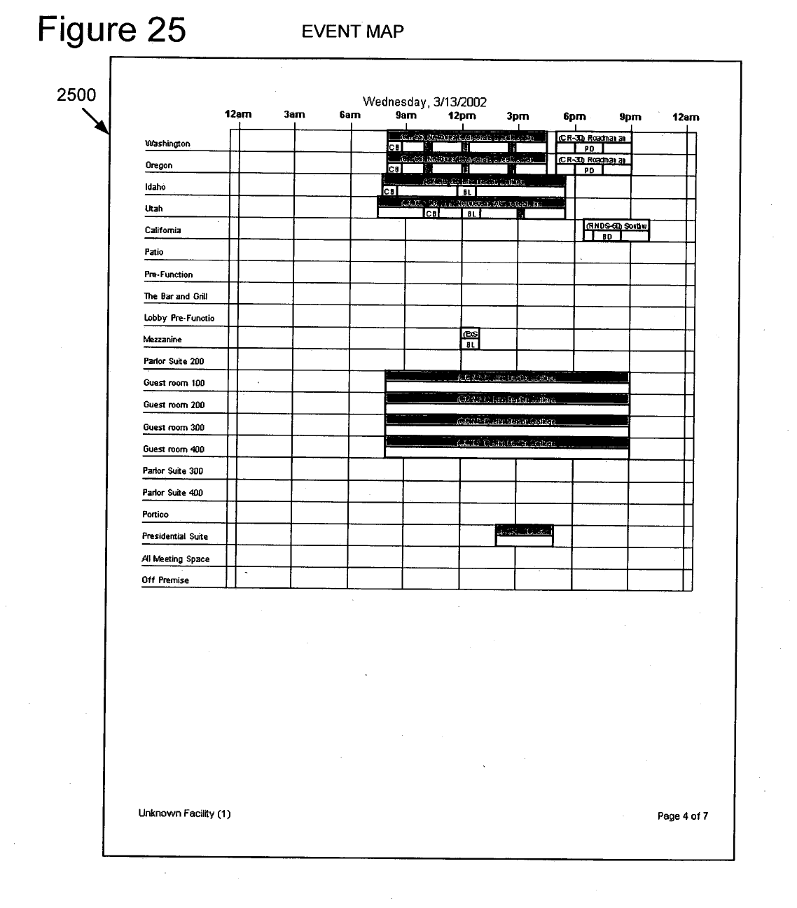

5) The ability to create “maps” 2500 (FIG. 25) outlining all events along with sub functions respective to each event. Such maps serve as a communication tool and visual aid to instill a greater sense of knowledge and urgency for all employees, so that they're aware of business volume, timing, and who is handling setup, service and teardown for each event.

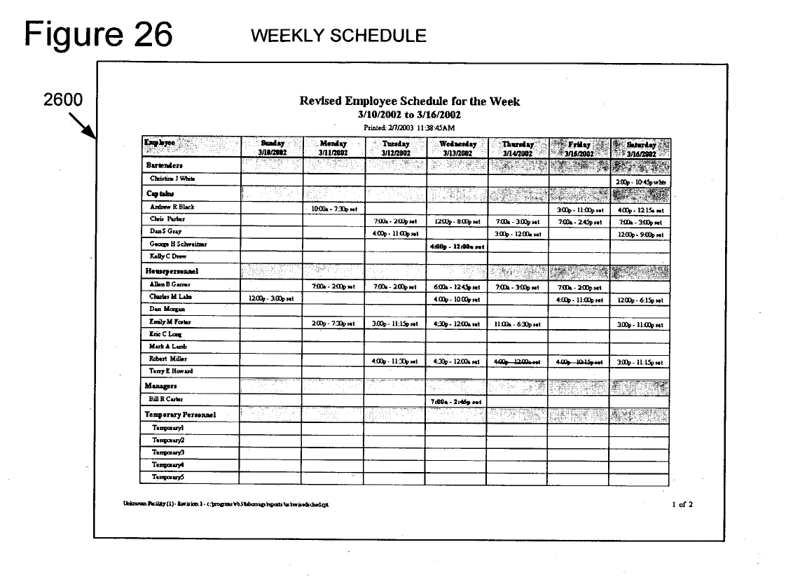

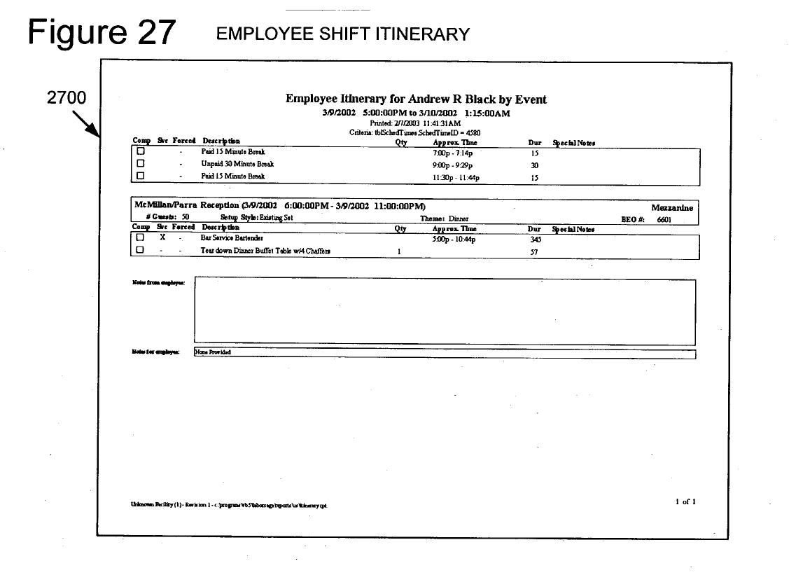

6) The ability to create schedules 2600 (FIG. 26) by assigning all setup, service and teardown oriented tasks to employees, either automatically by allowing the system to generate the schedule using HRIS selection features (outlined in #1 above), or manually by allowing the user to drop and drag assignments to specific employees.

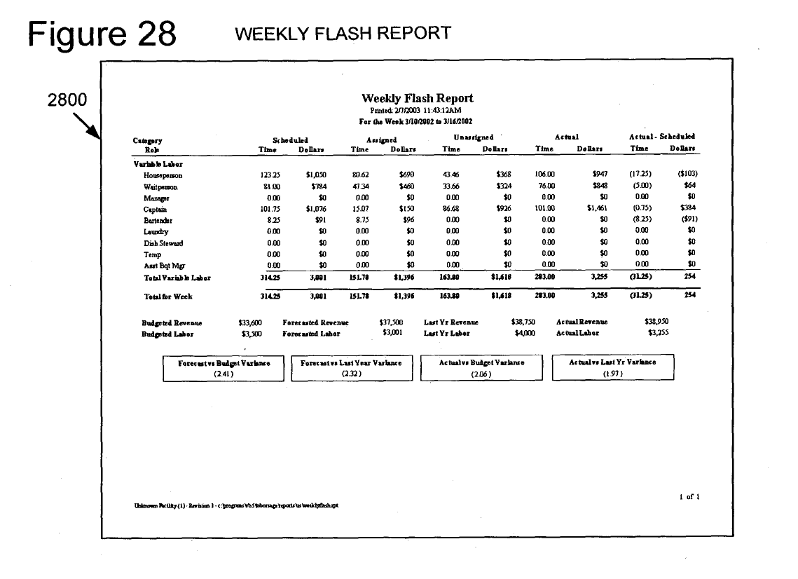

7) Report (e.g., weekly flash report 2800 of FIG. 28) options, which allow management the ability to:

a) Audit productivity

b) Isolate labor costs and recognize variances to budget and previous years

c) Track variances to actual hours worked

d) Identify exceptions with regard to:

i) inventory shortages

ii) employee performance

iii) event conflicts, etc...

### Workflow

The following Workflow detail provides a brief outline of an “Ideal Use” scenario for the system. This abridged representation is intended only to provide a brief summary of the workflow.

1) Configuration

a) At installation of the labor and resource scheduling system 210 at a facility, a detailed time and distance study analysis is performed for the facility encompassing at least the sellable rooms and storage areas, resources, tasks and employees that are specific to the respective facility. In the study, the times for employees to travel between any combination of the rooms is measured. Further, timing relating to specific resources and/or configurations thereof for particular events also is measured, such as timing to set up, preparation, take down and cleaning of an 8′ table in both banquet and classroom configurations. These measurements can be made, for example, using a stop watch and measurement tapes or wheels, etc. As discussed further below, the automatic scheduling procedure bases calculations of the time required for various tasks for events based in part on this time and distance study analysis information.

2) Preliminary Tasks

a) Event Sales Staff 230 enter Banquet Event Orders (BEO) in their Event Management System (EMS) 220 as sales are made.

b) BEO's are printed and provided to Scheduling Manager (SM) 240 on a weekly basis.

c) Any changes, relative to previously booked BEO's are submitted via “change order” on a daily, or as needed basis.

3) Import of EMS Information Output Data

a) SM 240 performs initial review of BEO's, after which SM 240 initiates an import from the labor and resource scheduling system that connects dynamically to EMS information output data to acquire needed information for the week being scheduled plus several days prior to and beyond the week.

i) While processing the data, the following is performed automatically by the labor and resource scheduling system:

(1) Themes and room setup styles of BEO's are identified to automatically create service tasks and resources to be set by personnel.

(2) Themes are used to identify default functions to perform, such as lunches, dinners, breaks, etc. These functions are then used to automatically create service tasks and resources to be set by personnel.

b) SM 240 performs manual review of each BEO for the week and 1 to 5 days after the week (based upon the SM's preferred advance setup period, performing the following steps:

i) Checks date of BEO data against printed version. (Note: hard copy BEO data provided by EMS are regarded as the “Master” or “Bible” and serve as the ultimate reference for answering event specific questions. The SM is just checking to ensure that any information critical to scheduling personnel is accounted for in Labor and resource scheduling.

ii) Adds additional sub functions, resources or service tasks that may have been typed in to notes on BEO in the EMS 220 and were not picked up in specific fields by the labor and resources scheduling system 210.

iii) Checks quantities of automatically generated resources to ensure they are consistent with the BEO.

iv) Removes/cancels BEO's that may have been cancelled but left as active (definite) in EMS.

v) Adds BEO data that may not have been included automatically. Change or delete BEO data that may not reflect the needs of the events.

vi) Marks each BEO as Complete once validated, and any corrections, if necessary, have been made.

4) Initial Scheduling for Week (performed 2 or more days prior to start of week)

a) SM 240 Initiates 1 of two scheduling options:

i) Manager Assisted Scheduling

(1) SM 240 generates individual assignments and recurring shifts to be given to personnel. He may also optionally choose to assign assignments to the recurring labor shifts. He may optionally choose to assign selected service tasks to employees automatically.

ii) Automatic Scheduling

(1) SM 240 generates individual assignments, recurring shifts, and variable labor to be given to personnel. He may also optionally choose to assign assignments to the recurring labor shifts (variable labor shifts are always assigned assignments).

b) SM 240 starts assigning remaining assignments to personnel starting 1 day prior to the facility's chosen start of week. Manager assisted scheduling leaves all, or the majority of assignments, assignable at the SM's discretion where as automatic scheduling intelligently chooses employees, times and assignments with no initial interaction by the SM.

i) SM 240 views the day's schedule, events and unassigned assignments.

ii) SM 240 assigns supervisory staff to cover events held during the day and optionally fills a percentage of their shift with assignments.

iii) SM 240 drags unassigned assignments singly or in groups (by event, event date or type of assignment, which can be Pre-Event, Event-Service or Post-Event) to a chosen employee to create a shift and itinerary. While viewing the itinerary, the SM can optionally choose additional assignments to add.

iv) SM 240 may opt to change shifts or assignments which were automatically assigned (i.e., if he elected to use the automatic scheduling option), by dragging to other employees or by removing assignments and reassigning to other personnel.

5) Reporting

a) SM 240 prints schedule for the week to be posted for employees.

b) SM 240 prints event maps to be posted for employees.

c) SM 240 or SM's designee print individual itineraries for all events & all employees on a daily basis. Event itineraries are then to be posted and attached to each BEO. Individual itineraries are provided to each employee upon arrival to work.

d) SM 240 or SM's designee print supervisory checklists for ease in reviewing/confirming event setup & service arrangements are appropriately handled.

e) SM 240 prints labor variance reports (defined in more detail in the functional specification) to be reviewed by SM with further review by 1 or more of the controller, general manager or food and beverage director.

6) Daily Scheduling Maintenance (performed 1 day prior to work day)

a) Changes to BEO's (“change orders”) are provided to SM from sales department in markup form on the original BEO or in a change sheet (common facility standards).

b) SM 240 modifies appropriate information on each event (i.e., Guest counts, room, setup style, etc.), which results in the following automatic actions by the system 210:

i) Assignments that change as a result of the change to the event (i.e., 50 chairs required rather than 25) are recreated and unassigned from the itinerary they were originally attached to.

ii) The affected shift is flagged as a “Changed” shift.

c) SM views labor schedule using an option in the system that highlights all shifts that have been affected by event changes (“Changed” shifts).

i) SM views each shift and reassigns assignments, shortens shifts, and removes shifts as necessary.

ii) SM views remaining unassigned assignments for the day in question and creates new shifts to assign them to.

d) SM prints revised schedule for the week, which compares the current schedule against the original schedule generated at the beginning of the week and shows deleted shifts in strike-through font, new shifts in bold and changed shifts using a combination of strike-though and bold.

e) SM reprints event map for the day, if needed, as well as any necessary variance report (if labor was greatly affected).

7) End of Week Review

a) SM 240 extracts timekeeping output information regarding the actual times worked by employees from the facility's time clock system, or, if unavailable, manually enters hours.

i) SM prints punch detail report for the week and verifies times to ensure accuracy.

b) SM 240 prints actual vs. forecasted variance reports (further defined in functional specification) to verify employees are working within their defined shifts. Problem employees are identified and notes are made in the Labor and resource scheduling HR module if needed.

i) Actual vs. forecast variance reports are provided for further review to one or more of the Controller, General Manager or Food and Beverage Director.

### Functional Specification

1) The System 210 is capable of being translated to a different local (Country), which requires that:

a) All text, captions, prompts and the like are stored in a central location (a local file) that can easily be swapped out with another version for a different spoken language. For example, when we are ready to translate to Spanish, we can simply send this file out to a translator and include it in the Spanish version of the product.

b) Measurements are configurable or generic enough to allow for standard or metric entry.

2) The System 210 is capable of retrieving required BEO data information dynamically from Event Management Systems (EMS) 220.

a) The EMS 220 will generate information that serves as the “foundational” resource for all BEO's, unless Labor and resource scheduling is installed in a property which has no EMS and requires manual BEO entry. If an EMS 220 is not in place, data entry forms are provided to enter this required information into the System 210's database. In either scenario, the BEO data used to perform the scheduling and labor analysis has been input into the “Labor and resource scheduling” system 210, but will, with use of the interfaces for any EMS BEO data, appear to be in the same location for the purpose of querying and updating. In the absence of an EMS 220, the system 210 allows entry of the minimum BEO information required to create an Event Map. This minimal information consists of:

i) The date and time of the event, including “Room Ready”, “Function Start” and “Vacate” times.

ii) The theme of the event.

iii) The break and serving times.

iv) The headcount (setup guest count).

v) The room the event will be held in.

vi) The setup of the room (preferably a graphic representation as well).

vii)The service standard of the event.

viii) Customer information (contact, address, billing details, etc.).

ix) Notes for each event that outline additional requirements or concerns (e.g., bar setup, hors d'oeuvres, reception, parking, pool, suites, etc.).

3) Further information used by the system 210 is:

a) Staff member information:

i) Available work times, with the ability to block out specific days for requested time off.

ii) Times each employee prefers to work.

iii) Regular and OT wages (or Salary).

iv) Hire/termination date.

v) Possible roles the staff member can be placed in (Waiter, Lead waiter, captain, etc.).

(1) Priority of each role (Who should be picked from first and last).

(2) Regular and OT wages.

(3) Skill level (on a scale from 1 to 10).

vi) Individual scheduling parameters:

(1) Minimum shift.

(2) Maximum shift.

(3) Maximum days to work per week.

(4) Suggested days to work per week.

(5) Minimum hours per week (recommended).

(6) Maximum hours per week (recommended).

vii) Lifting ability (on a scale from 1 to 10).

viii) Performance/HR notes (tardiness, sick, unexcused absence, etc.).

ix) Recurring schedule information:

(1) Job role.

(2) Day of week.

(3) Start and end time.

b) Rooms in Facility (Storage and Rental):

i) Travel time between every possible combination of rooms.

ii) Maximum advance setup (some rooms, such as restaurants can not be set 2 to 3 days out).

iii) Allowed event setup styles and guest capacities for each.

iv) Combination rooms (what rooms can be converted to create new rooms).

v) Properties specific to each room (i.e., large doorway, high speed internet access, view, etc.).

vi) Resources already in existence in each room (i.e., Built-in bars, conference tables, etc.).

c) Resource definitions:

i) Quantity available:

(1) Makes resources unavailable (due to being under repair loaned out, etc.) between specific dates.

(2) Tracks history of availability.

(3) Where the resource is located.

ii) Capacities of guests per resource for different setups (e.g., 10 guests can sit at a 8′ folding table when set up in banquet style, but only 4 guests can sit at the table when setup in a classroom style).

iii) Labor time required to Prepare, prepare for transport, transport, setup, teardown and clean the resource with transportation time adjusted by mode and type of resource being moved:

(1) Unlimited adjustments must be able to be made to any of these times based on the volume of resources being set/transported.

iv) Lifting requirements (on a scale of 1-10 to match personnel lifting capabilities).

v) Minimum number of personnel that can be assigned to the setup/tear-down each resource.

vi) Package definitions:

(1) What resources are a part of this resource (i.e., a “Silverware Package” resource may contain a “Knife”, “Fork” and “Spoon”, each of which have been defined as individual, or “Raw”, resources.

(2) Packages may include other packages (i.e., a “Place Setting” package may contain the above mentioned “Silverware Package” in addition to a “Plate”, “Glass” and “Napkin.”

(3) Timings can be recursed into package items. In other words, the timing defined on the “Place Setting” package may include only the time to set the “Plate”, “Glass” and “Napkin”, in which case, the “Place Setting” resource must be looked at separately to determine additional timing.

vii)Resource Substitutions (i.e., an 8′ rectangular table can be used in place of a 6′ rectangular table if inventory runs low.

viii) Maximum time in advance of an Event that the resource can be set (i.e., Tables and Chairs may be set up to 3 days in advance where as Audio-Video (for security purposes) can only be set the day of the event.

ix) Employee skill level required to handle the resource.

d) Task Definitions (Tasks represent/define services to be performed, such as waiting on a lunch or servicing a break).

i) Recurring Tasks (e.g., routine maintenance duties such as janitorial, cleaning chandeliers, replacing light bulbs or stripping and waxing hallways):

(1) The frequency the task is to be created:

(a) Daily (every n days):

(b) Weekly (Every n weeks on 1 or more of Saturday, Sunday, Monday, Tuesday, Wednesday, Thursday, or Friday)

(c) Monthly. One of the following:

(i) Day n of every n months

(ii) The (1^{st}, 2^{nd}, 3^{rd}, 4^{th} or Last) (Saturday, Sunday, Monday, Tuesday, Wednesday, Thursday, or Friday) of every n months.

(2) The date the first task will be created.

(3) The time(s) of the day the tasks will run. One of the following two options:

(a) Once at a specific time.

(b) Every n hours between a specified start and end time.

(4) The personnel required to service the task:

(a) Number of personnel.

(b) Role(s) the personnel will be working under (e.g., house person, server, maintenance, etc.)

(c) Employee skill level required to perform the task.

(5) Notes or duties to be displayed on the employee itineraries, providing the ability to give personalized input to the individual assigned the task.

ii) Automated Tasks (generated by events):

(1) The start time and end time of the event:

(a) Start time can be adjusted from the beginning or end of a specific function (i.e., Lunch, Event, Break, etc.) or can be generically set as starting “Prior to Setup” or “Immediately Following Teardown.”

(b) End Time can be adjusted from the beginning or end of a specific function, or can be set as a specified time after the task starts.

(c) Both start and end times can be adjusted further by a set interval or the number of guests for the event (positive or negative) and the room the event is held in.

(d) Staggering can be performed if a task generates too many assignments to bring employees in at varied times to cover the function on a FIFO (first in-first out) basis.

(2) The personnel required to service the task:

(a) Number of personnel.

(b) An additional number of personnel based on guest counts.

(c) The minimum number of personnel that should be assigned regardless of the guest count.

(d) The maximum number of personnel that should be assigned.

(e) Role(s) the personnel will be working under (e.g., house person, server, maintenance, etc.)

(f) Employee skill level required to perform the task (defined in two groups in such a manner as the first n percent of employees will be 1 skill level and the remaining employees will be another).

(3) Notes or duties to display on the employee itineraries who are assigned this task.

e) Theme definitions:

i) Themes must be compatible with existing themes in facility's EMS BEO Data. Additional themes can be added as needed.

ii) Resources to add to an event with this theme (e.g., Weddings will require cake and gift tables)

iii) Tasks to add to an event with this theme (e.g., a Dinner theme may require coat check personnel)

iv) The ability to designate optional colors to print events of this theme on Event Maps or to display time-bars in the schedule form.

v) A default function to create when an event with this theme is imported from the EMS (i.e., A Dinner theme may cause a “Plated Dinner” function to be created if this is the most common type of dinner in the facility)

f) Room setup style definitions:

i) Set styles must be compatible with existing styles in facility's EMS BEO data. Further styles can be added as needed.

ii) Resources to add to an event with this style (e.g., Classroom setup styles may require chairs, 6′ classroom tables, water glasses, note tablets & apothecary jars with candy for attendees).

iii) Tasks to add to an event with this setup style (i.e., Classroom setup style may require freshening room/water during a break).

iv) The ability to designate optional colors to display event time-bars of this style on the schedule form.

g) Functions:

i) Allowance for a default duration for any function.

ii) Whether the function is a “Meal” or an “Event.” There can only be 1 “Event” function defined.

iii) Definable default times to start all functions (i.e., Plated lunches normally start at noon).

iv) Resources to add to an event with specific function types (i.e., Plated lunch might require the addition of a place setting)

v) Tasks to add to an event with this function (e.g., Plated lunch would require the “Wait on Plated Lunch” task and possibly runners to assist wait personnel).

vi) The ability to designate optional colors to print sub-functions on the Event Map or to display functions within event time-bars on the schedule form.

4) The system 210 is capable of extracting information output regarding actual hours worked from facility Time Management Systems (TMS).

a) Times consist of the date and time of the shift and the role the employee was clocked into during the shift. This role should be matched up to the roles defined in Labor and resource scheduling for use in reporting variances between system scheduled hours and actual hours worked..

b) The system allows the facility to choose from a list of supported TMS systems to allow for TMS changes after the initial installation.

5) Scheduling capabilities are provided as follows:

a) Entering/Reviewing BEO's:

i) Upon successfully extracting BEO data of events for the week (plus 5 days), the SM has specific capabilities to complete the review of all events. The same capabilities are required for those facilities without an automated EMS:

(1) A data entry form that allows both an individual BEO view and a view of all BEO's (in list form) for the week plus 5 days prior and 5 days after the week.

(2) The ability to change the time of the overall event as well as the time of individual functions within the event.

(3) The ability to view/change all required tasks, resources and the resultant assignments quickly.

(4) A separate statistics section that shows information specific to the event:

(a) Total time for all assignments related to the event as well as a breakdown by the individual employee roles the assignment(s) fall under.

(b) Total labor dollars assigned to the event and broken down by roles in the same manner as the assignments above.

(c) The earliest time any setup for the event can be/has been assigned.

(d) The latest time any setup for the event can be/has been assigned.

(e) The latest time any teardown for the event can be/has been assigned.

(f) The latest time any teardown for the event can be/has been assigned.

(5) The ability to print reports specific to the event, such as a “Supervisor Event Setup Checklist” or listing of service staff attending all events, for a supervisor's ease in reference.

(6) The ability to set the following guidelines to schedule for an event or create event specific assignments:

(a) Identify “recurring events” which define a string of events by the same group that may require a “Refresh” to a room, rather than the additional time of a “Reset.”

(b) Off site events for outside catering needs, defining travel and lead time requirements.

(c) Room presets for events which require “quicksets”, i.e., there is insufficient time between the event requiring setup and previous events, to set the event up under normal time/personnel allowances.

b) Generating Labor

i) The user has been provided the ability to choose the level of automation when generating a schedule. There are two basic approaches to scheduling: “Automated” and “Manager Controlled.” Automated scheduling allows the system to initially choose employees and create itineraries on its own and Manager Controlled scheduling allows the manager to choose employees and the assignments they will be given. The options a user is given when choosing to generate a schedule are:

(1) Generate assignments—Choosing this option will recreate all assignments on events from scratch, removing changed assignments from shifts if they are already assigned. If the user chooses to start a fresh schedule, all assignments will be removed.

(2) Clear labor—When a schedule is initially created, no shifts will exist, so this option is innocuous at that stage, however subsequent schedule generations, as a result of starting from scratch or simply trying to auto-assign assignments that have been created from a new or changed events, will require the user to choose whether to clear all shifts or leave them in tact.

(3) Generate recurring schedules—Choosing this option will create shifts for any employee that has recurring schedules defined. You can optionally choose to assign or not assign assignments to these employees at the time of generation.

(4) Generate variable labor—For those SM's who prefer to allow the system to generate the first draft of the schedule, this option should be chosen.

ii) Automated generation of labor. The following must be taken into account when creating shifts and assigning assignments:

(1) Creating the schedule is an iterative process of first determining a reasonable time to assign a shift, choosing the best employee for the shift, creating the shift, assigning the most appropriate assignments out of all assignments “1qualified as available” to the employee during the shift, and finally removing any unassigned time (i.e., compressing a shift to eliminate any unnecessary unassigned time that extends beyond the last task/assignment given to an employee).

(a) Determining the next reasonable start time has been accomplished by scanning all unassigned assignments and choosing the lowest latest start time of a sliding time window assignment or the lowest start time of a fixed time frame assignment. Several factors have been taken into account to determine the possible time frame of sliding time window assignments (sets and teardowns):

(i) If a portion of the assignment is already assigned a start time any additional reliant assignment must be suggested as the same time previously assigned.

(ii) If the assignment is to be done during a quickset situation (quicksets are defined as sets and teardowns that must occur between two events where a minimum specified time gap does not exist), reliances (e.g., vacuuming not performed until all teardowns are accomplished) must be ignored.

(b) Choosing the best employee for the shift:

(i) Using the assumed start time, a summarization of roles, required skill levels and total time will be compiled for all assignments that can be assigned during a normal shift, using the start time plus the number of hours that will be defined as a facility standard shift. These roles will be used to determine an initial weight for each employee, some of whom will be disqualified.

(ii) Adjust weight determined above by each employee's seniority, wages, hours already worked, requested time off and requested time on.

(iii)Increase weight if the employee is already on shift and the shift can be expanded to take on the assignments. Likewise, decrease the weight if the new shift will cause a split in the day (or disqualify if splits are not allowed)

(iv)Increase weight if the employee has not worked the suggested number of days. Likewise, decrease weight if they have gone over the suggested days per week or disqualify if they have achieved the maximum days per week.

(v) Choose the employee with the highest weight as the ideal candidate.

(c) Create the shift and assign assignments:

(i) The shift will be created using the facility's standard shift length, unless the employee's primary role provides for a different length shift. The employee's minimum or maximum shift length will then adjust designated shifts appropriately.

(ii) Once the shift has been created, the system will scan the compiled list of assignments, adding quickset assignments first, then fixed time frame assignments and finally sliding time frame assignments.

c) Manually creating shifts and itineraries:

i) Upon completion of automated scheduling (if chosen), the assignments that were unassignable due to a shortage of personnel will be displayed in an “Unassigned Assignments” form that allows a viewable display of the entire week's assignments or those of any specific day.

ii) A schedule form that shows a graphical representation of the events and shifts (in timeline format) can be used to complete the assignment process. The Event schedule shows all possible rooms down the left side of the control and the entire week plus and minus 5 days across the top. The Labor schedule shows all employees down the left side of the control and the same time period across the top. Both schedules are synchronized in such a manner that the times being viewed remain the same.

iii) The unassigned assignments form displays assignments in a linear table format or in an outline format broken down by assignment type (pre-event, event service or post-event), then date of event and finally by event. The two different views can be alternately selected by the user and the last utilized is remembered so that an individuals preferences remain constant each time the software is run.

iv) Methodology has been provided to allow the user to interactively create an event or an employee shift by dragging (using the mouse) over the correct time period and event or employee. In the same manner, the user is able to move an existing event or shift to another time or room/employee.

v) Event time bars have optional color designations to provide a good visual indication of certain information about all events:

(1) Status (definite, cancelled, etc.),

(2) Service Standard,

(3) Theme,

(4) Setup Style,

(5) Data verification progress (marked as complete, verified, or neither), and

(6) Ideal times for scheduling specific assignments.

vi) Event time bars also display below them, at the user's choice, another bar that displays either the functions held within the event at the time in which they are to be held, or the percent of assignments that have been assigned.

vii) Labor time bars are colored to provide a good visual indication of certain information about the shift:

(1) The role the employee is working under.

(2) The uniform the employee is directed to wear during the shift.

(3) Whether the shift's itinerary has changed since the last time changes were cleared by the user. A shift's itinerary changes when an assignment is removed through any method other than direct manipulation of the shift through the itinerary functions (e.g., an event's guest count is changed, which regenerates new assignments and removes them from existing itineraries).

viii) Also displayed below labor time bars, upon user's choice, is another bar that displays a graphical representation of the time that has been filled with assignments or a bar indicating if OT (overtime) exists and at what time during the shift OT will be paid.

ix) The labor graph also displays preferential times an employee has requested to work or not work by blocking them out in different colors and patterns so that it is easily identifiable as time on/off or less/more available.

6) The system provides the following reports (at a minimum):

a) Event Map(s).

i) Prints a graphical representation of the Event Schedule per day for every day of the schedule week for all or any rooms that have an event or optionally inclusive of rooms that do not have events. This report shows the name of the event, the setup style and number of guests with time bars that identify the start and end time of the event as well as the start and end times of the functions within the event. A list of employees setting up, servicing and tearing down all events can optionally be provided for each day.

b) Labor variance report(s).

i) Compares the actual time worked vs. the forecasted time (system generated) for a selected period of time.

c) Unassigned labor comparison report(s).

i) This report compares the total hours assigned to employees versus the system forecasted hours (total of generated assignments) to provide a glimpse into the “tightness” of scheduling for a selected period of time.

d) Labor forecast report

i) This report displays the summary of forecast hours, dollars (labor and revenue) for forecast, last year and budget and calculated percentages of labor dollars to revenues. The forecast vs budget variance (percentage point swing) will also be displayed.

ii) A revised version of this report (Actual Labor vs. Forecast) will display the same information but will add a comparison between forecast and actual labor.

e) Weekly schedule report

i) This report displays the traditional schedule for employees broken down by the role the employee must work. It also identifies the uniform to be worn. Revised schedules can be printed, which show changes made during the week.

f) Resource Locations.

i) This report details the movement of individual resources (chosen by the facility) for a specified time range. The date and time available/unavailable, the site of relocation, and the event or reason for the movement will be displayed. This report must also take into account any inventory that has been made unavailable through the resource unavailability screen.

g) Employee itineraries

i) This report displays the individual assignments to be carried out by personnel during their shift, the times the assignments are to occur and the event/room they are to occur in. The SM must have the ability to make notes on the itinerary or notes an each individual assignment if necessary.

ii) This report can optionally be expanded to include very specific detail outlining what is included in a resource package (or steps for a service task), as a benefit to newly hired employees that are not familiar with the composition of packages.

h) Event Itineraries

i) This report displays the list of all assignments for an event, who is scheduled to perform the work and when they are to perform it.

i) Event setup checklist

i) This checklist, to be attached to individual BEO's, displays all assignments to be performed for setup and teardown on an individual event. As employees set up or tear down resources, they are to check off the items that they have completed. The supervisor can then review the checklist and sign off as appropriate.

j) Event service checklist

i) This checklist provides a daily list of all meal service tasks to be completed with the responsible employee and an initials box for each employee to acknowledge that they have performed the service.

k) Event duration report

i) This report lists all events held, the corresponding room, setup style, theme and the total time and the estimated dollars that have been assigned and must be assigned to Pre-Event (setup), Event Services (meals, etc.) and Post-Event (teardown) tasks.

1) Punch detail report

i) This report displays the times and roles that have been manually entered or imported into the software from the external timekeeping software.

m) Exception report

i) This report displays exceptions (minimum exceptions listed below) encountered during the scheduling process. The exceptions are generated by the user after completing BEO input, but prior to creating the schedule.

(1) No event name.

(2) No expected guest count.

(3) No room, setup style or theme selected.

(4) Not marked as complete or verified.

(5) Duration of event greater than 24 hours.

(6) Travel or lead time exists, but event is not marked as off-site.

(7) Travel or lead time does not exist on an event marked as off-site.

(8) Event marked recurring that does not have a matching event which follows.

(9) Event not marked recurring that does have a matching event which follows.

(10) Sub-function date outside the range of the event.

(11) Preset to “room” selected, but the preset date is invalid (too early or too late).

(12) Resource Shortages

7) The following reports are also provided to display information pertaining to the setup of the system.

a) Employees

i) Contact List—a list of all active employees with name, address and phone numbers.

ii) Scheduling Parameters List—A list of all employees and the labor rules specific to them (i.e., minimum shift, maximum shift, minimum work week, etc.). This report will also be able to provide the employee's allowed work roles as an option.

b) Resources

i) Resource Packages—All package resources and the resources they are made up of. This can be printed in extended format, as well, which displays further information about the elements of the package (Use timings and allow substitutions).

ii) Resource List—All resources in the system with timings for setup/teardown broken down by resource category. Flags such as “Force Teardown” or “Include on Equipment Requirements Report” will also be listed.

c) Rooms

i) Room Distances—All distances factors entered for the rooms in either seconds or factors.

ii) Room List—A list of all storage and rental areas and their maximum advance setup times. This report can optionally include the capacities for each setup style.

d) Tasks

i) Recurring Task List—Displays a list of recurring tasks and the rules for the time of occurrence. Can be printed with or without the list of required personnel to service the task.

ii) Non-Recurring Task List—Displays a list of non-recurring tasks which are generated automatically by the BEO's which have been scheduled. Can be printed with or without the list of required personnel to service the task.

e) Room Setup Styles—Displays a list of defined room setup styles. Can be optionally printed with the resources or tasks required by the setup style.

f) Event Sub-functions List—Displays a list of defined sub-functions. Can be optionally printed with the resources or tasks required by the function.

g) Themes List—Displays a list of defined themes. Can be optionally printed with the resources or tasks required by the theme.

h) Budget Groups List—Displays a list of defined budget groups.

i) History Category List—Displays a list of defined employee history categories.

j) Employees Roles List—Displays a list of defined employee roles.

k) Event Status List—v of defined event status'.

l) Holiday List—Displays a list of defined holidays.

m) Manual Tasks List—Displays a list of defined manual tasks

n) Resource Availability Categories—Displays a list of defined resource availability categories.

o) Resource Categories List—Displays a list of defined resource categories.

p) Room Groups List—Displays a list of defined room groups.

q) Room Properties List—Displays a list of defined room properties.

r) Event Standards List—Displays a list of defined event standards.

s) Uniforms List—Displays a list of defined uniforms.

t) User List—Displays a list of the defined system users.

u) Role and Permissions List—Displays a list of all permission roles and the permissions that have been granted to each permission object. Permission objects are those forms and reports that can be granted specific permissions, such as update, delete, admin, etc.

### Procedures

The procedures defined in this section represent the logic that needs to be explained to understand the scheduling process. Understood processes, such as saving or deleting records, printing reports and checking permissions will not be discussed as they are common to all applications and do not need explanation.

The diagram below shows the basic process the SM will utilize on a daily basis to create and maintain a schedule.

### Introduction to Assignments

Schedules are generated using one basic element: an assignment. It is important to first understand how the system generates assignments before learning how the system generates schedules. An assignment is a specific to do for an individual, such as “Transport and Setup 10 chairs in the Washington Room for the LaborSage group at Oct. 30, 2002 11:30 PM.” To arrive at this assignment, we must first enter BEO's, then let the system determine the resources and tasks that are needed and convert them into assignments. This process is broken down into the following sections: (1) BEO Entry, (2) Task/Resource Generation and (3) Assignment Generation.

### BEO Entry

As BEO entry is uncommon to the entry of other information, such as employees, rooms, themes, setup styles and functions, it is being included in the procedures section of this document. Specifically, the ability to import the information output generated from external applications needs to be addressed. FIG. 2 represents the basic application of the BEO interface:

As illustrated in FIG. 2, the process starts with the entry of the BEO's into the EMS 220 by the event sales staff 230. This information is then retrieved by the Labor and resource scheduling system 210 in process A (and sent through a filter appropriate to the EMS being used in process B. This filtered data, now converted to a format familiar to Labor and resource scheduling, is then placed in the Labor and resource scheduling database in process C for use in creating assignments and ultimately a schedule.

### Process A—Retrieving EMS BEO's

The process of retrieving BEO data is defined loosely as each EMS 220 (FIG. 2) can have different storage methods. With this in mind, the two most common methods will be explained. The first and most common method involves retrieving the BEO data that has been stored in a common file format from the EMS computer and loading that data onto the labor and resource scheduling system computer 210 so that it can be accessed independently. EMS systems commonly store the BEO data in Dbase, FoxPro or MS Access format, which makes retrieval moderately easy through the use of ODBC (Open Database Connectivity). The second method involves BEO data stored in a server-based database management system such as MS SQL Server. This type of database requires that facilities access the data directly from the computer it is stored on. There is only 1 step in this process:

1) Create temporary copy of information output pulled from the EMS system. This step does not occur if the EMS system uses a centralized (server based) database management system such as MS SQL Server.

a) In most cases, this involves nothing more than creating a batch file on the SM's computer that performs a COPY command of the information output from the EMS folder to a local folder.

i) This batch file will be customized based upon the EMS system in place.

### Process B—EMS Filter

Most EMS systems in use today are based upon the same model. This commonality allows us to acquire the information necessary to creating an Labor and resource scheduling BEO without manual entry by the SM. The information output pulled from the EMS systems will consist of:

1) Event Name, Contact and phone number

2) Room event is held in.

3) Date and time of event.

4) Setup style of the room.

5) Event theme.

6) Guest count.

7) Status (definite, pending, etc.).

8) Notes.

9) Additional resources required.

This information output will be accessed from the temporary files created in process B or directly from the DBMS if using a centralized system. The steps required to retrieve this data are as follows:

1) Establish connection to information output using appropriate ODBC settings found on the Labor and resource scheduling server.

2) Utilizing a procedure specific to the EMS system being used, retrieve the BEO's for the week plus 5 days. Store these retrieved records in a temporary table in the Labor and resource scheduling Database.

a) For each BEO retrieved, retrieve a list of additional resources and store in a temporary table in the Labor and resource scheduling Database.

### Process C—Create Labor and resource scheduling BEO's

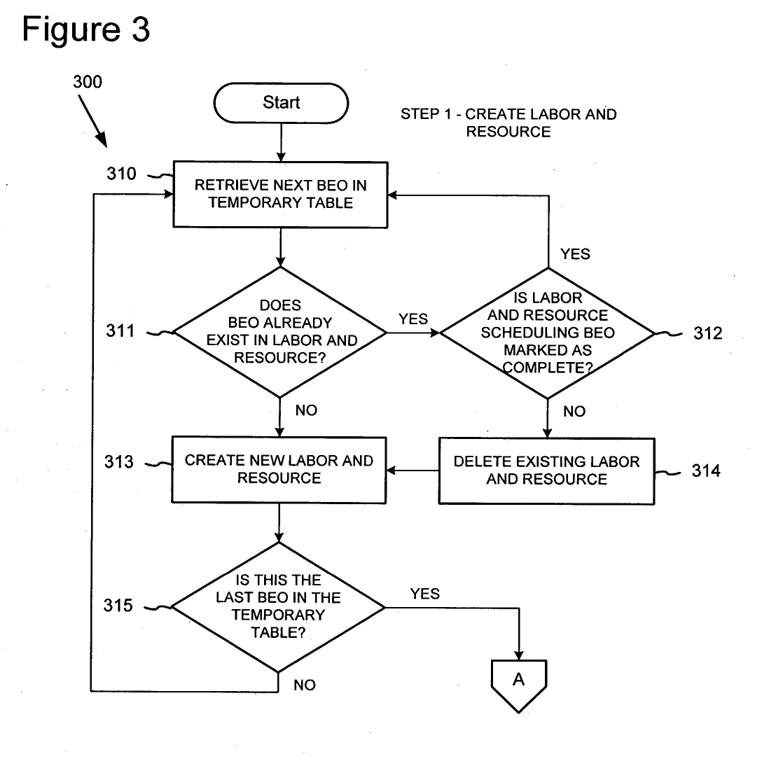

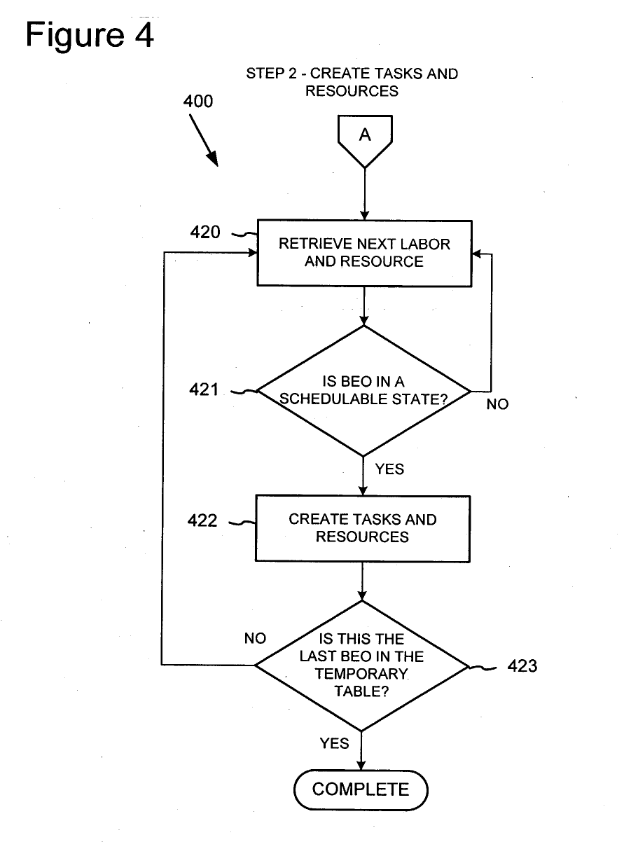

With reference now to FIGS. 3 and 4, the final process of the BEO import is the most involved. The BEO's that have been stored in the temporary tables must now be converted to Labor and resource scheduling BEO's and required tasks and resources must be created. The diagram below illustrates the basic process:

The first step (Create Labor and resource scheduling BEO's) process 300, loops through the temporary BEO table that was populated in process B and creates or deletes/creates the actual BEO's Labor and resource scheduling will be using for scheduling. The second step process 400 will then loop through the list of newly created BEO's and determine what tasks and resources need to be added to each.

Step 1 process 300:

1) For each BEO in the temporary BEO table that is in a status that has been defined as “Schedulable”, perform the following:

a) Retrieve 310 the Event ID of an existing Labor and resource scheduling BEO using the EMS system′ BEO and function number.

i) If the Event ID exists 311, then this BEO has been imported before. If the user has already reviewed this BEO and made changes, it should be ignored. The user is directed to check the “Complete” checkbox upon initial review and entry of additional resources and tasks. This flag will be used to determine whether or not to ignore this BEO. If “Complete” is checked 312 then go back to the first step (a), retrieving 310 the next BEO. If “Complete” is not checked, delete 314 this BEO and continue on with the next step (b).

b) Create 313 the Labor and resource scheduling BEO using the information obtained from the temporary BEO.

i) Look up the default sub-function corresponding to the Event's Theme. If one exists, create it using the date and time of the event as the functions' date and time.

ii) Add the resources, if any, from the temporary table.

Step 2 process 400:

1) For each BEO created in Step 1 that is in a status that has been defined as “Schedulable” 420, 421 and 423, perform the following:

a) Create 422 required tasks.

i) Add required tasks for the setup style and theme as well as tasks for any of the sub-functions that were created.

ii) If the event is marked as a recurring event, add any tasks that have been defined as recurring tasks.

iii) Using the room the event is held in, retrieve the list of tasks that should be run when the last event held was in a defined list of rooms rather than the room this event is held in. An example is necessary to explain this in detail:

(1) If a ballroom exists that can be converted into two rooms (room A and Room B) by putting a divider in place, then there are three rooms defined in the system: Ballroom, Room A and Room B.

(2) If the Ballroom was the last room in use, and the new event is being held in Room A, then it stands to reason that the partition will have to be put in place prior to the event.

(3) Room A would be defined as needing to run a “Setup up divider” task when the Ballroom was last in use. Consequently, the Ballroom would be defined as needing to run the same task when either Room A or Room B was last in use.

b) Create 422 required resources.

i) For each resource defined as needed for the setup style, theme and each sub-function, perform the following:

(1) Determine the quantity of resources required.

(a) If the quantity defined on the setup style, theme or sub-function is greater than zero, use it, otherwise, determine the quantity as follows:

(i) If the resource already exists as part of the event and the quantity to add is zero, which means calculate the quantity based upon the capacity and guest count, and 1 or more of the resources already existing were added using a capacity and guest count calculation, do not add anything.

(ii) Determine the capacity of the resource for the setup style of the event.

(iii)Divide the guest count by this quantity and round to the next whole number (i.e., 97 guests for a 6′ round in a “Rounds of 8″ setup style which has a capacity of 8 per table would be calculated as: Round up (97/8)=Round up (12.125)=13).

(2) If the resources already exist in the room, deduct the quantity that exists in the room from the quantity to add. If this result is negative, it may cause resources to be removed from the room later in the process.

(3) If the resource already exists, add the quantity to it, otherwise, create a new resource record.

c) Create 422 list of resources that must be removed from the room.

i) For each resource defined in the room as “Remove if not Required”, perform the following:

(1) Determine the quantity to remove

(a) If the resource is needed in the room as a result of the previous step titled “b) Create 422 required resources.”, remove the number of resource required from the number of resources already in the room. If the result is less than zero, then change the number of resource required n the room and do not remove any, otherwise, remove the appropriate number from the room to leave the amount required.

(2) If it has been determined that resources need to be removed from the step above, add the resource to the list of those to be removed.

### Assignment Generation

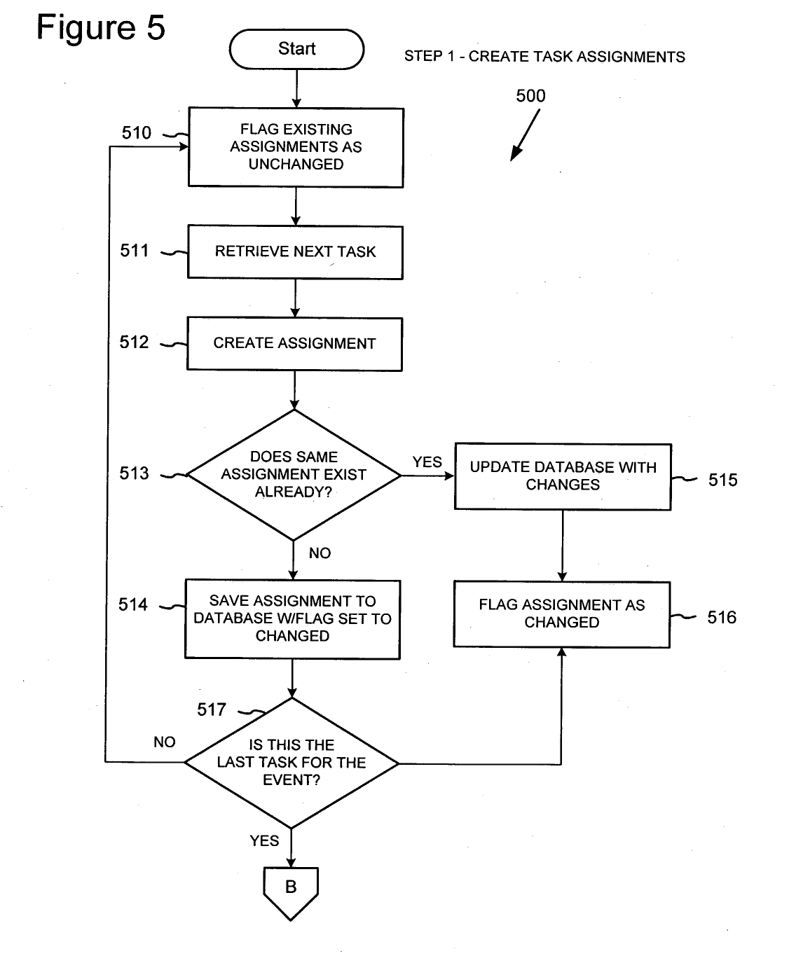

After the completion of the BEO import and review process, the SM 240 (FIG. 2) is now ready to create a schedule using the system 210. To do this, the required tasks and resources must first be converted to assignments, after which, the assignments can be used to create the required shifts. Assignments may have already been generated during the BEO entry process for many BEO's, but one can not assume that all assignments have been created. Therefore, a process 500 (FIG. 5) exists to regenerate assignments for all BEO's prior to generating the schedule. The process 500 for generating assignments is the same whether they are being generated on the fly as events are being reviewed or whether they are generated all at once prior to schedule generation, therefore an explanation of what causes assignments to be generated is provided separately from how assignments are generated.

There are three separate actions that cause the generation of assignments:

1) User clicks the “Generate New List of Assignments” button while viewing an event in the Event Order form.

2) User makes changes to any of the following data on an Event and clicks the Save button:

a) Recurring Event flag.

b) Off Site flag.

c) No Setup flag.

d) No Teardown flag.

e) Room Setup Style.

f) Theme.

g) Room.

h) Room Override.

i) Preset to Room.

j) Preset no later than ______

k) Event Status.

l) Service Standard.

m) Planned Guests.

n) Travel Time.

o) Lead Time.

p) Sub Functions (i.e., new functions added, dates change, etc.).

q) Resources.

r) Tasks.

3) User chooses the “Generate Assignments” option when generating the labor schedule.

If assignments are generated as a result of making specific changes to an event as explained in item 2 above, events surrounding the event being changed can also be regenerated. Surrounding events are the events held prior to or after the current event in the same room. Any changes to the following information will cause the surround events to recalculate their assignments as well:

1) Recurring Event flag.

2) Off Site flag.

3) Room Setup Style.

4) Theme.

5) Room.

6) Event Status.

7) Planned Guests.

8) Event Start Date.

9) Event End Date.

10) Resources.

11)Tasks.

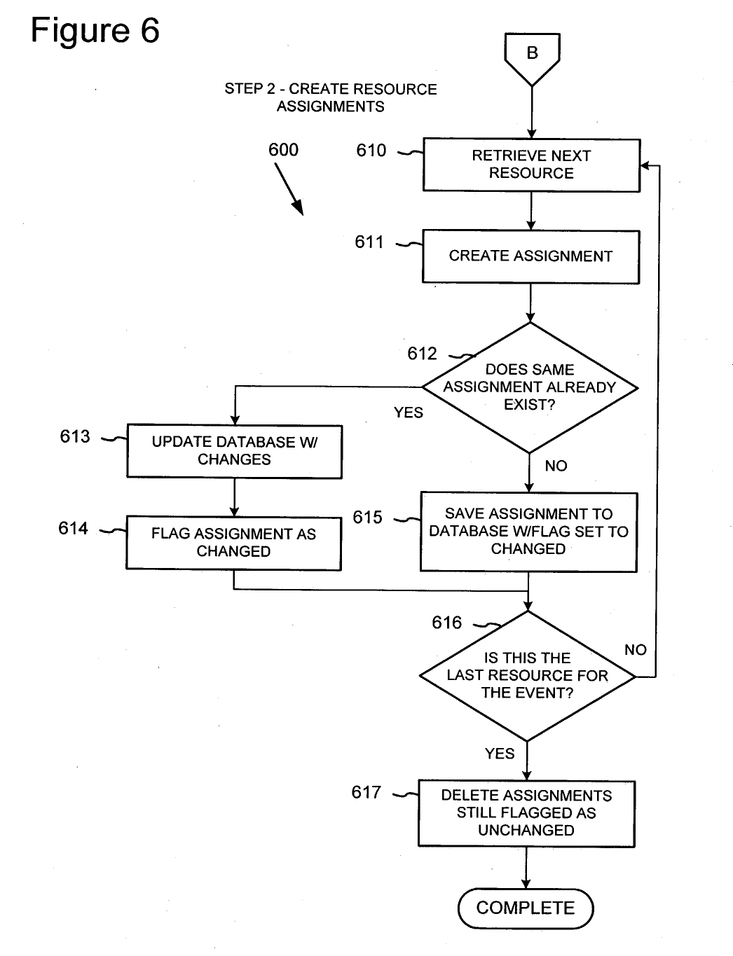

The generation of assignments is performed on an event by event basis no matter which method above causes them to be generated. When choosing to generate assignments prior to generating the labor schedule, the system 210 simply opens each event and performs the same process as clicking the “Generate New List of Assignments” button. The assignment generation process 500, 600 will be explained as though the assignments for 1 event were being generated. The flowchart in FIGS. 5 and 6 illustrates this process 500, 600 in a very simplified manner.

The two process steps 500, 600 are nearly identical in the way assignments are generated, but there are enough differences to warrant two separate explanations. The first and last items 510, 617 in the flowchart (flag existing assignments 510 and deleted still flagged assignments 617) are helpful in dealing with changes to events without having to reassign all assignments. The idea is simple: set a flag on all existing assignments for the event that identifies the assignment as unchanged 510, then, while creating the new assignments 512, if a match is found 513, unflag it 516, keeping it assigned to any shifts it may already be assigned to. When we delete 617 the assignments at the end that are still flagged, we are in effect deleting any assignments that are no longer needed by the event or have been replaced with an assignment that is different in some manner (i.e., time or quantities change). The result of this method is that only assignments that change get unassigned from individuals, which makes dealing with changes a bit easier for the SM.

After the assignments have been flagged 510, the first step is to go through all tasks for the event 511 and create the assignments 512. This is step 1 of the process:

Step 1 process 500 (Create Task Assignments):

1) For each task required by the event 511, perform the following:

a) Determine start and end times of each assignment to be created 512 (more than 1 assignment can be created by a task).

i) If the task has been added manually by the SM the start time is provided by the SM and the end time is calculated by adding the duration of the task to the start time.

ii) If the task is recurring (not assigned to an event):

(1) Calculate the day each assignment will be assigned based upon the schedule defined on the task. The three possible schedules are:

(a) Every n days

(b) Every n weeks on 1 or more of Su, Mo, Tu, We, Th, Fr, Sa.

(c) Monthly (two options):

(i) Day n of every n months.

(ii) The (1^{st}, 2^{nd}, 3^{rd}, 4^{th} or last) (Su, Mo, Tu, We, Th, Fr or Sa) of every n months.

(2) For each day it has been determined the task must run, calculate the times it should be run. There are two options for the times:

(a) Occurs once at hh:mm a/p

(b) Occurs every n hours between hh:mm a/p and hh:mm a/p

iii) If the task is assigned to an event (not recurring or manually added):

(1) Calculate the start time using one of the following defined options on the task:

(a) At the beginning of a specific function.

(i) This will create a start time for every matching function on the event.

(ii) Can be adjusted cumulatively based upon the flat minute adjustment, number of minutes per guest, flat minutes based on the room the event is held in and a number of minutes per guest based on the room the event is held in.

(b) At the end of a specific function

(i) This will create a start time for every matching function on the event.

(ii) Can be adjusted cumulatively based upon the flat minute adjustment, number of minutes per guest, flat minutes based on the room the event is held in and a number of minutes per guest based on the room the event is held in.

(c) Immediately prior to setup:

(i) This causes the start time to be left open ended at the time the assignment is created. When assignments are scheduled, the start time will be set.

(ii) The end time will be determined by adding the calculated duration of the task to the start time when the assignment is scheduled.

(d) Immediately following teardown:

(i) Just as with the “Immediately prior to setup” option, the start and end times are left open ended until the assignment is scheduled.

(2) Calculate the duration or end time using one of the following options:

(a) At the beginning of a specific function.

(i) This will create an end time for every matching function on the event.

(ii) Can be adjusted cumulatively based upon the flat minute adjustment, number of minutes per guest, flat minutes based on the room the event is held in and a number of minutes per guest based on the room the event is held in.

(b) At the end of a specific function

(i) This will create an end time for every matching function on the event.

(ii) Can be adjusted cumulatively based upon the flat minute adjustment, number of minutes per guest, flat minutes based on the room the event is held in and a number of minutes per guest based on the room the event is held in.

(c) Some time after the task starts

(i) Calculates the end time by adding the accumulation of the flat minute adjustment, number of minutes per guest, flat minutes based on the room the event is held in and a number of minutes per guest based on the room the event is held in to the start time calculated above.

(ii) If the start time is open ended, the end time will be left open ended as well, providing only a duration to help calculate the end time at the time the assignment is scheduled.

b) Determine the number of personnel required to service the task grouped by role, start/end time and skill level. One assignment will be created 512 for each unique combination of Employee role, start/end time and skill level.

i) For each personnel record defined for the task, perform the following:

(1) Divide the number of guests attending the event by the “Per # Guests” field truncating the decimal portion (i.e., both 1.2 and 1.8 would result in 1) to the nearest whole number.

(2) If the remainder of the above division plus the “Per # Guests” field is greater than the maximum guests per employee, add 1 to the result.

(3) If the result of the first two steps is zero, and the number of guests is greater than the minimum guests per employee, add 1 to the result.

(4) If the result of the first three steps is less than the minimum personnel defined, then set the result to the minimum personnel.

(5) If the result of the first four steps is greater than the maximum personnel defined, then set the result to the maximum personnel. The result at this point is final.

ii) Determine the number of personnel and their skill levels in each of the two groups if the number of personnel is greater than 1.

iii) If the task requires staggering and there are more employees required than have been defined, perform staggering. (This needs to be expanded in the future to include the algorithm for creating staggering).

c) Create one assignment for each personnel, searching for an existing assignment first. If an existing assignment is found, update any information that has changed and set the unchanged flag to changed. If a matching assignment is not found, create a new one. Matching assignments are any assignments that match all of the following criteria:

i) Event ID

ii) Task ID

iii) Start and end time

iv) Skill level

v) Employee role

Step 2 process 600 (Create Resource Assignments):

1) For each resource required by the event and each resource that must be removed from the room prior to the event 610, 616, perform the following 611-615 (only if the event is not marked offsite and the resource has times defined):

a) Determine the maximum number of days to setup in advance by taking the lowest of the following:

i) The max setup days for the room.

ii) The max days entered on the schedule form by the SM.

iii) The max days the resource can be set up in advance.

b) Determine the earliest setup time using the max advance setup and the earliest setup time defined on the resource. If an event is held in the same room or any combination room that does not complete until after the earliest setup time, adjust the earliest setup time and latest start accordingly. If the earliest setup time is adjusted higher than the latest start, then try to allow at least four hours by adding extra time to the latest start, as long as it does not exceed the start time of the event.

c) Determine if there is a quickset before the event or after the event by comparing the time between the last event and next event against the quick set time defined in the system. If the times are less than or equal to the defined quick set time, then they are considered quick sets.

d) Determine the quantities to be set up and torn down by checking the previous and next events for the same resources.

i) If the resources exist, then pre-event assignments will only consist of setup time (transportation and prepare for transportation will be ignored) and post-event assignments will consist of tear down and clean time, excluding transportation time from the teardown.

ii) If the events are marked as recurring events then no teardown or setup will occur with the exception of the first and last events in the group of recurring events, which will still follow the above rule for excluding transportation times if the events prior to and after them contain the same resources.

iii) NOTE: “Same” resources are those that have a matching resource ID only. The system will not recognize different packages that contain the same or similar items within them.

e) Calculate the duration each of the following 5 steps will require for the resource and, if the resource is a package, accumulating the same timings from the resources within the package:

i) Preparation time:

(1) Determine prep time per resource by adding any volume adjustments found for the quantity of resources being prepared to the base preparation time and then multiply that time by the number of resources.

ii) Preparation for transportation time:

(1) Determine transportation and preparation time per resource by adding any volume adjustments found for the quantity of resources being prepared for transportation to the base preparation for transportation time and then multiply that time by the number of resources.

iii) Transportation time:

(1) Determine how many trips will need to be made by dividing the number of resources required by the maximum resources that can be transported in one trip and rounding to the next highest integer.

(2) Determine the distance the resources must be moved by finding the closest storage room to the room the event is held in that holds this resource and getting the distance factor between it and the event's room. If the resource is being removed from the room for an event, the room used will be from the Event's room to the room defined as the temporary holding room for the resource (in Room definitions under resources in room).

(3) Multiply the system defined walk-time by the distance factor and add to it the transportation time (adjusted by quantities just as with the prior timings) multiplied by the distance factor.

(4) Multiply this time by the number of trips required to determine total transportation time.

iv) Setup time:

(1) Determine setup time per resource by adding any volume adjustments found for the quantity of resources being setup to the base setup time and then multiply that time by the number of resources.

v) Teardown time:

(1) Determine transportation time in the same manner as above.

(2) Determine teardown time per resource by adding any volume adjustments found for the quantity of resources tearing down to the base tear down time and then multiply that time by the number of resources.

vi) Clean time:

(1) Determine clean time per resource by adding any volume adjustments found for the quantity of resources being cleaned to the base clean time and then multiply that time by the number of resources.

f) If the event prior to this event is a quick set, reduce all of the above times by the quick set percentage defined, otherwise increase them by the pad percentage defined.

g) Determine the skill level, lifting ability and employee roles for each of the steps (prep, transportation, setup, teardown and clean)

h) Merge the times for Pre-event assignments and post-event assignments when the employee role is the same (use the highest skill level and lifting ability determined) to minimize the number of assignments that are created. Rather than creating separate Preparation, transport and setup tasks, create assignments that merge all (i.e., 1 assignment that says “Prepare, transport and setup 10 chairs”). In this manner, a maximum of two assignments should normally be created for each resource in an event.

i) NOTE: For resources that are being removed from a room during an event, the teardown assignment will be created prior to the event and the setup assignment will occur after.

j) Create 611 each assignment, searching 612 for an existing assignment first. If an existing assignment is found, update 613 any information that has changed and set 614 the unchanged flag to changed. If a matching assignment is not found, create 615 a new one. Matching assignments are any assignments that match all of the following criteria:

i) Event ID

ii) Resource ID

iii) Assignment type (transport, setup, teardown, etc.)

iv) Earliest start and latest end time

v) Duration

vi) Skill Level

vii) Lift ability

viii) Employee role

### Auto-Scheduling

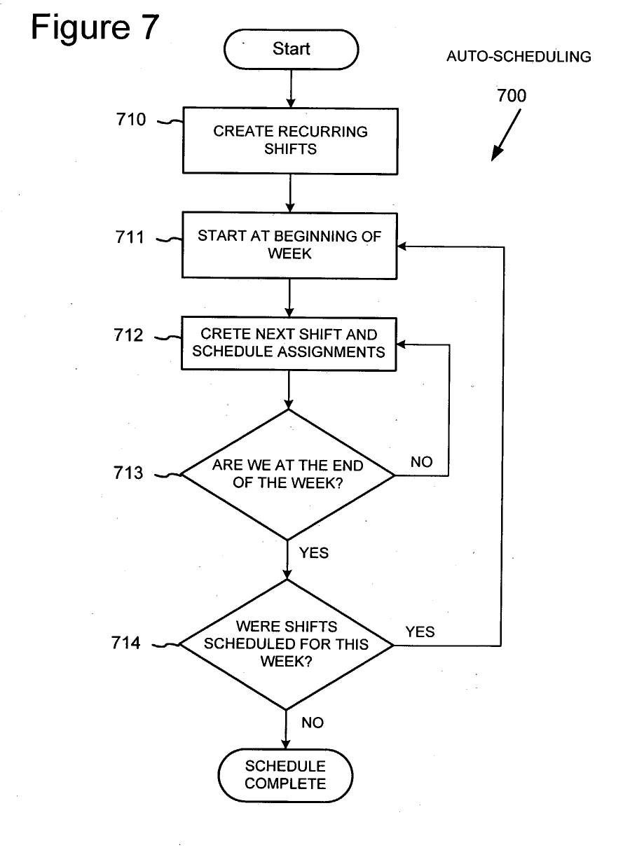

There are two basic approaches to scheduling: Manager Controlled and Automated. Manager controlled scheduling gives the manager full discretion of the personnel to use and the start and length of the shifts, however, the assignments must still be scheduled using their timing restrictions that have been generated automatically. For Manager controlled scheduling, this process is unimportant as it is skipped entirely. Many SM's may choose to allow the system to create the entire (or as much as possible based upon existing personnel) schedule automatically. Once complete, the SM 240 only needs to choose the supervisory coverage, change shifts that are too short or handed out to inappropriate personnel and hand out any remaining assignments that could not be automatically scheduled due to auto-assignable personnel shortages. FIG. 7 summarizes the process 700 the system utilizes to complete a schedule.

The basic idea behind the automated scheduling process 700 is that the system loops through the entire week, picking the best time to create a shift and tries to find someone to assign assignments to. If no personnel can be found, the system will continue on through the week with later assignments. At the end of the week, if at least 1 shift was successfully assigned, the entire process starts over until the entire week is reviewed without 1 successful shift. At this point, the system has “done its best” to assign all assignments. The remaining assignments are to be dealt with by the SM by assigning to supervisors or more intelligently rearranging schedules.

### Recurring Schedules

The first step in the automated scheduling process 700 is to optionally create recurring shift schedules 710 if any have been defined by the facility. The SM 240 is given an option to schedule assignments to the recurring schedules when generating or to leave them in an unassigned state, meaning that the employee will not have an itinerary to work with. This process is simple and does not warrant a detailed description of the process. Suffice it to say that a shift is created on the exact day and time that the employee's recurring shifts have been defined as and assignments are scheduled using the same process as will be explained further in this section.

### Creating Remaining Variable Labor Shifts

Once recurring shifts 710 have been completed, the system starts 711 the process of creating variable labor shifts until all assignments have been handed out or a shortage of personnel precludes any further assignments. This process is very involved and will therefore be split into three separate topics: “Determining a time to start a shift”, “Determining an employee to assign to the shift” and “scheduling assignments.” These three topics are all a part of the “Create next shift and schedule assignments” step 712 in FIG. 7. The remaining steps 713, 714 in the flowchart are self-explanatory and need no further explanation.

Determining a time to start a shift process 800:

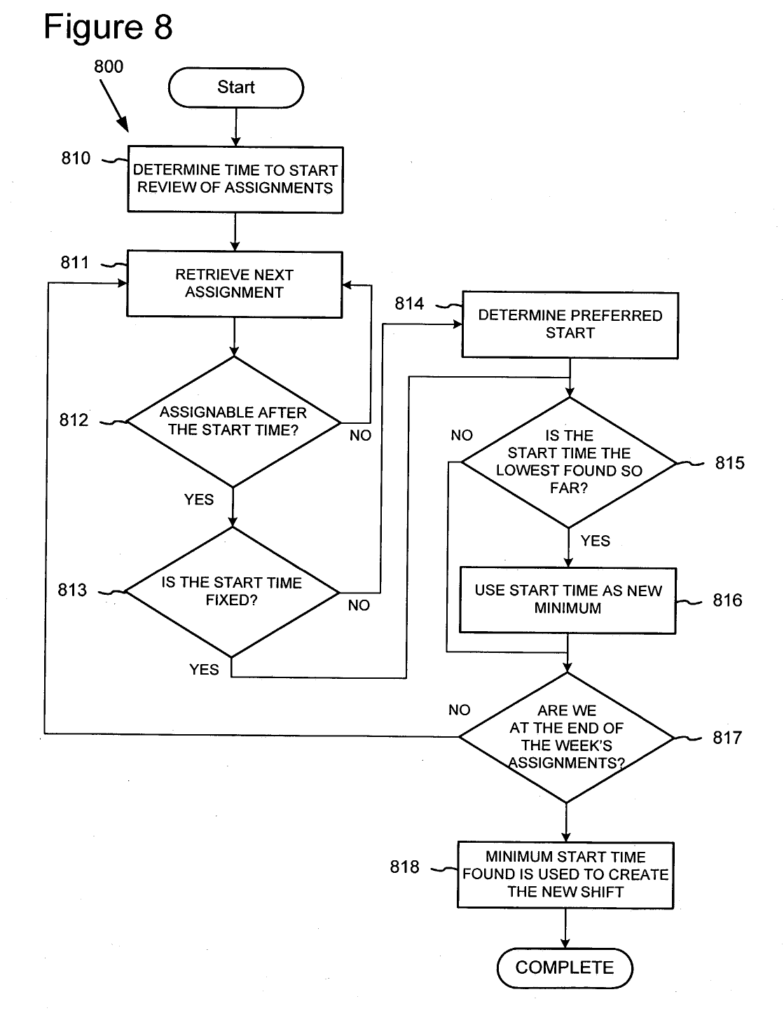

With reference now to FIG. 8, this process 800 can be defined in simple terms as “Find the latest possible start time that can be used that encompasses the earliest schedulable assignments that are as yet unscheduled.” This procedure must know what time to start looking for assignments, which, at the beginning of scheduling, is the start of the week, but as shifts are created, the start time is moved forward. FIG. 8 illustrates this process 800.

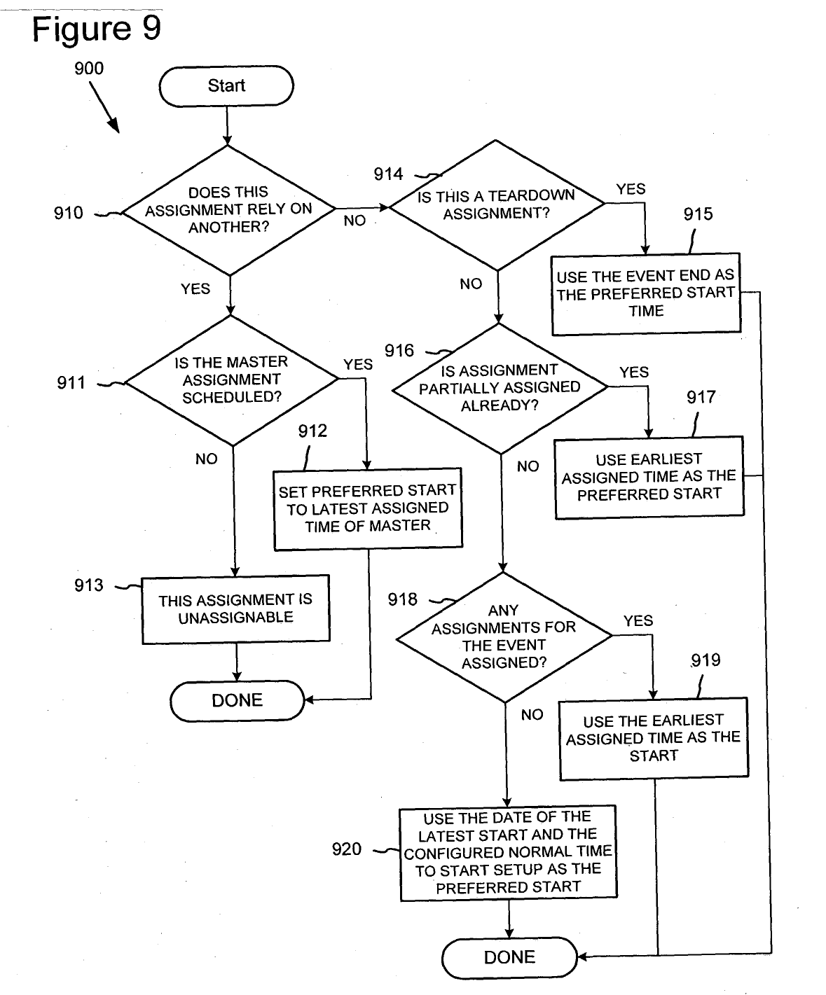

This process 800, with the exception of determining the preferred start time of sliding window assignments, is simpler than FIG. 8 shows. It is nothing more than a loop that keeps trying to find the lowest possible start time of all assignments that can be assigned beyond a specific date. The process 900 of determining the preferred start time of a sliding time-frame assignment is more involved as FIG. 9 illustrates.

The steps below detail the entire process 800, 900 for determining the time to start a shift (as shown by FIGS. 8 and 9):

1) The time to start reviewing assignments is determined 810:

a) If this is the first shift being created, the minimum schedulable time is set to the beginning of the week.

b) If, while attempting to schedule an employee for a shift, none are found, then this time will be set to approximately 8 hours after the unassignable shift. In this manner, we can skip over times that are unassignable due to shortages in personnel.

2) Each assignment that is assignable after the start time 812 determined above is reviewed as follows:

a) Fixed time assignments 813 (created from a task, such as “Wait on Buffet Lunch”):

i) Preferred start is the fixed start time of the task

b) Sliding time-frame tasks 814 (created from either setup/teardown of resources or tasks-that have been defined with a start time of “Immediately prior to setup” or “Immediately following teardown”):

i) Preferred start is calculated 814 in process 900 (FIG. 9) as follows:

(1) If the assignment relies upon another being complete before it can be assigned 910:

(a) If the other assignment is not complete 911, then this assignment can not be assigned and is therefore skipped 913.

(b) If the other assignment is complete 911, the later of the other assignment complete time or the earliest time this assignment can be started is used as the preferred start 912.

(2) If the assignment is a teardown assignment 914, then the preferred start is the end of the event 915.

(3) If the assignment has been partially assigned already 916, then use the preferred start is the earliest the assignment has been scheduled 917.

(4) If any setup assignments for the event have been scheduled already, then the preferred start becomes the later of the earliest scheduled assignment for the event or the earliest time the assignment can be assigned.

Determining an employee to assign to the shift:

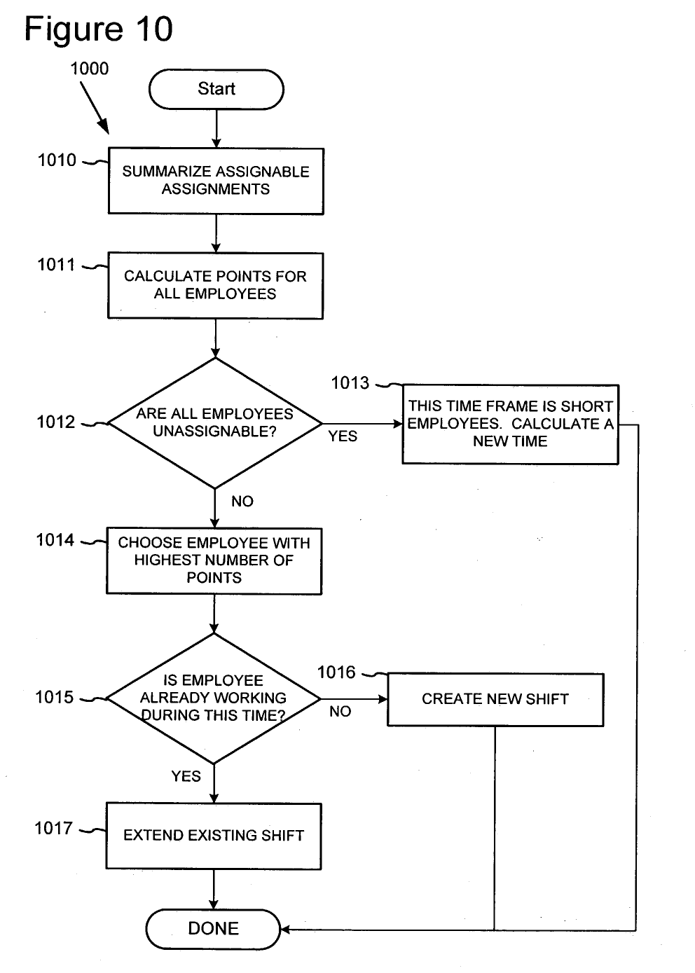

If a start time has not been determined from the steps above, then the scheduling process 800 is complete, otherwise, the next step is to determine who will work the shift being proposed. This process 1000 is illustrated in FIG. 10.

The preparation of summarizing assignable assignments 1010 is very simply going through all assignments that can be assigned during the shift and accumulating the duration by employee role as well as the highest skill level and lifting ability. This information is used in calculating the points each employee receives in the second step: Calculate points for all employees 1011. The second step is sufficiently complicated to warrant its own process explanation:

1) For each employee that is auto-assignable, calculate their points, or disqualify them, as follows:

a) Check shift against employee's availability times:

i) If the employee is marked as fully unavailable when the shift is intended to start, then they become disqualified.

ii) If the employee is marked as fully unavailable after the shift starts, but not until the employee's minimum shift has been reached, then the employee remains qualified and points are removed for each hour that the employee could not complete of the proposed shift.

iii) If this employee is marked as partially unavailable (a scale of 1 to 10) during any portion of the proposed shift, then the employee remains qualified and points are removed for each hour they do not wish to work into the proposed shift multiplied by the scale of unavailability defined.

iv) If the employee is marked as more available (a scale of 1 to 10) during any portion of the proposed shift, then points are added for each hour they wish to work into the proposed shift multiplied by the scale of availability defined.

b) If none of the roles the employee can assume match the roles that were summarized at the beginning of the assignment process then the employee becomes disqualified, otherwise, for each role that matches, points are awarded (higher if the matching role is the employee's primary role) and for each role's highest skill level and lifting ability that was summarized that falls within the employee's acceptable range. The points are adjusted by role based upon the number of hours of assignments that were summarized.

c) Points are awarded for the employee's hourly wage (lower wage means more points).

d) Points are awarded if the employee is already on shift during the proposed time frame and the shift can be expanded. The points are increased for every hour that the shift can be expanded.

e) Points are awarded if the employee has not yet reached their minimum work week, which are adjusted by the number of hours they are short.

f) Points are removed if the employee has reached their minimum work week, which are adjusted by the number of hours they have exceeded it.

g) Points are awarded if the employee has not worked their suggested number of days per week, which are adjusted by the number of days they are short.

h) Points are removed if the employee has worked their suggested number of days per week, which are adjusted by the number of days they have gone over.

i) The employee is disqualified if the proposed shift will increase their number of days worked beyond their maximum allowed.

j) If the system is configured to disallow splits and the proposed shift would cause a split, the employee will be disqualified. If the system allows splits and the proposed shift would cause a split, then points are removed.

k) Points are added for the seniority of the employee.

l) If overtime would be scheduled, the employee is disqualified.

It should be noted that all of the points above can be adjusted relative to each other based on weights that have been assigned in the system. The facility has complete control over how much weight to give wages, time off requests, matching roles and everything else defined above on a sliding scale. In other words, the facility could give wages no weight and time off requests a high weight, meaning points will not be added or taken away for wages, where a large number of points will be awarded or taken away for time off requests.

Once all points have been compiled, the employee with the highest number of points becomes the winner 1014. If no employees are available for the shift 1012, then a new start time is calculated 1013. A shift is created for this employee 1016 or the existing shift is extended 1017. Once this has been done, the shift will be given assignments, which is the final step in this process:

Scheduling Assignments:

There are two steps to scheduling assignments. The first is to choose the assignment and the second is to assign it. The processes below explain these steps. It should be noted that the processes below are assumed to be working with the subset of assignments that are assignable during the shift that has been created and that they are ordered by the earliest assignable time.

Step 1—Choosing the next assignment to assign:

1) For each assignment in the list perform the following (in order) until an assignment that is acceptable has been reached:

a) If the assignment is a quickset, choose it.

b) If the assignment is a fixed time-frame assignment and the time it must be assigned during the shift has not already been scheduled, assign it.

c) If the assignment's event matches an event already assigned to the shift, assign it

2) If none of the above match and all assignments have been gone through, go back through and choose the first available assignment.

3) If no assignments have been found at this point, the scheduling of assignments for this shift is complete.

Step 2—Assigning the assignment:

1) If the assignment is a fixed time-frame assignment, simply schedule it during the time it must be scheduled and proceed to the next step, otherwise, perform the following:

a) Find the first unscheduled gap in time that is sufficient to hold the entire assignment. If one is not found, perform the following:

i) If the assignment has already been assigned to this shift, find the next available gap in time, regardless of the duration.

ii) If the assignment has not been assigned, find the next available gap in time that is at least the duration of the minimum allowable split time configured in the system. If none found, this assignment can not be assigned to this shift.

b) If the entire assignment can not be assigned in the gap of time that has been found, adjust the duration down until it is evenly divisible by the number of resource that are being set/transported.

c) Assign the assignment and proceed back to step 1

After all assignments have been assigned, or the shift has been filled or none of the remaining assignments will fit into the available gaps in time, the process is complete. At this point, the shift is compressed (leading and trailing unassigned time is removed). If leading time is removed then the shift is expanded out by the amount of time that has been removed then the assignments are unscheduled and the process starts over again. The purpose of this step is that removing the leading time from a shift changes all breaks, which requires that assignments be reassigned to take the new breaks into account.

### Information Entry and Display

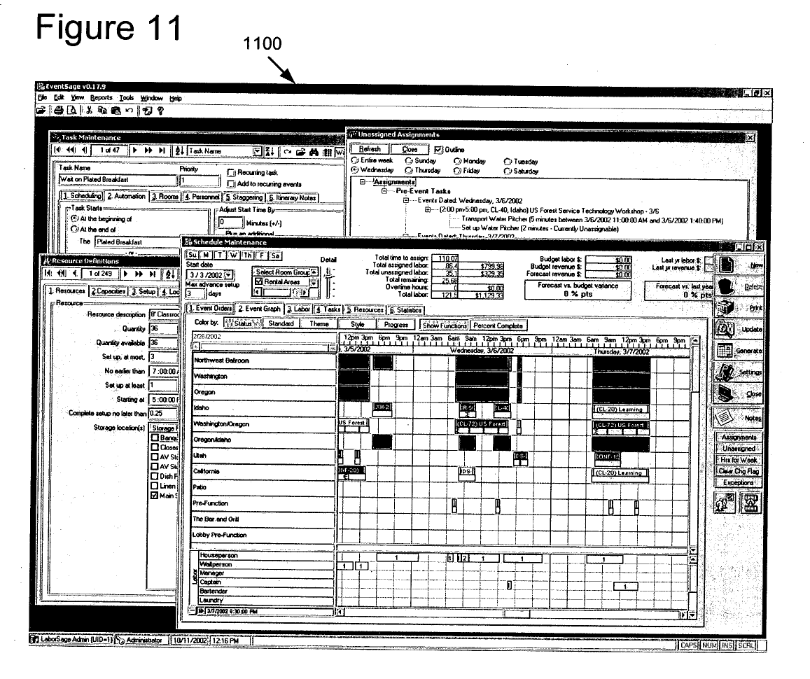

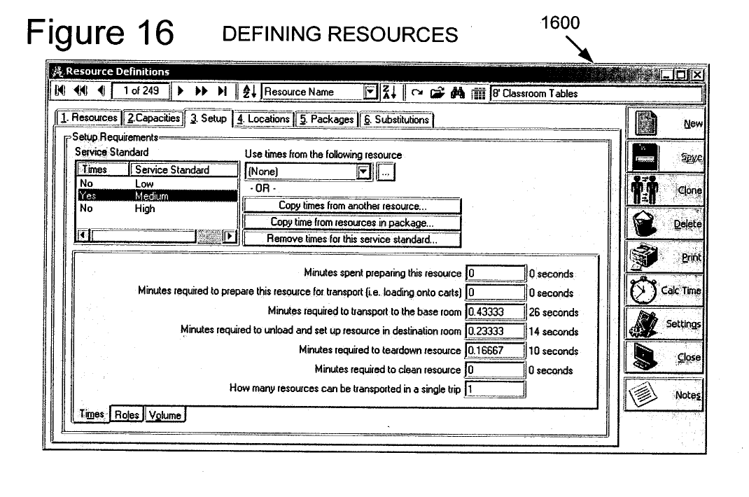

With reference now to FIGS. 11-23, the labor and resource scheduling system 210 (FIG. 2) provides various screen displays 1100 (FIG. 11) to the scheduling manager 240 (FIG. 2), including for entry and display of facility-specific configuration data defining resources, rooms, tasks and employees, such as with the time and distance analysis data discussed previously above relating to a respective facility at which events are scheduled by the system. The scheduling manager (SM) 240 or other user adds, edits or deletes data from the definitions via keyboard, mouse or other pointing device inputs, such as textual entry, drag and drop and cut/copy/paste operations.

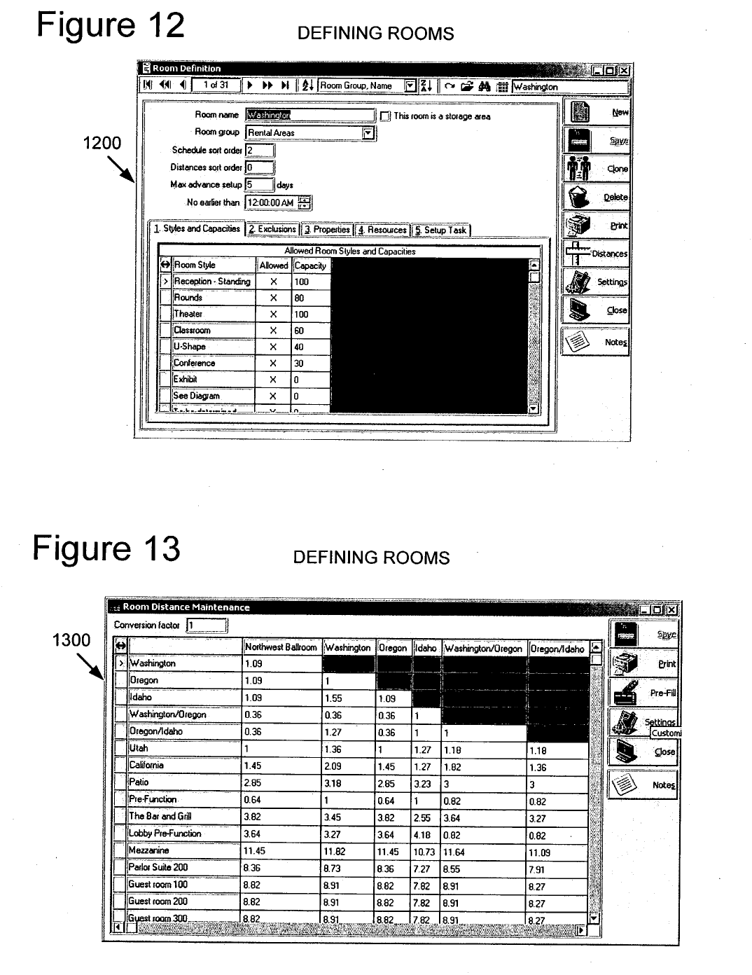

FIGS. 12-14 illustrate screen displays 1200, 1300 provided by the labor and resource scheduling system 210 for entry and display of data defining rooms at the facility. As shown more particularly in a rooms data collection worksheet 1400 (FIG. 14), the room definitions include timing for traveling distances between each combination of various sellable rooms and storage areas of the facility, allowed room configurations, pre-function space, and fixed and/or temporary room resources. This data is typically configured at installation of the system for a scheduling at the respective facility based on performing measurements and timings at the facility (e.g., by use of a stopwatch, measuring tape, and the like). The data can be further modified or added to after initial configuration.

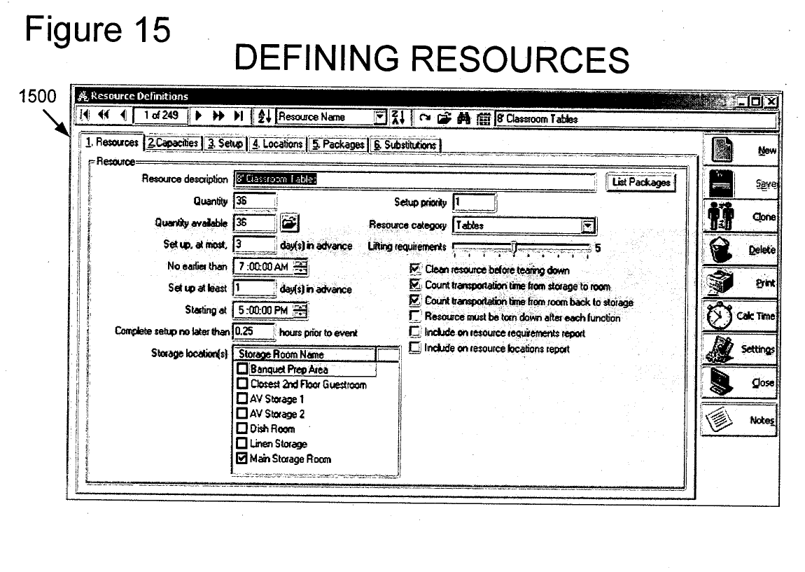

FIGS. 15-17 illustrate screen displays 1500, 1600 provided by the labor and resource scheduling system 210 for entry and display of data defining resources at the facility. As shown more particularly in a resources data collection worksheet 1700 (FIG. 17), the resource definition data includes quantities of the resources available at the various rooms, as well as parameters for setup, preparation, transport and take down task assignments. This definition data includes timing information from time and distance analysis performed at the specific facility and typically entered at configuration of the system to schedule events at the facility (e.g., at installation). More particularly, every resource pertinent to scheduling at the facility is defined in detail from time and motion study analysis done prior to installation of the system for the facility. This data is used during automatic scheduling by the system discussed above to determine times for task assignments to prepare, transport, setup, teardown and clean the resources. The data can be further modified or added to after initial configuration.

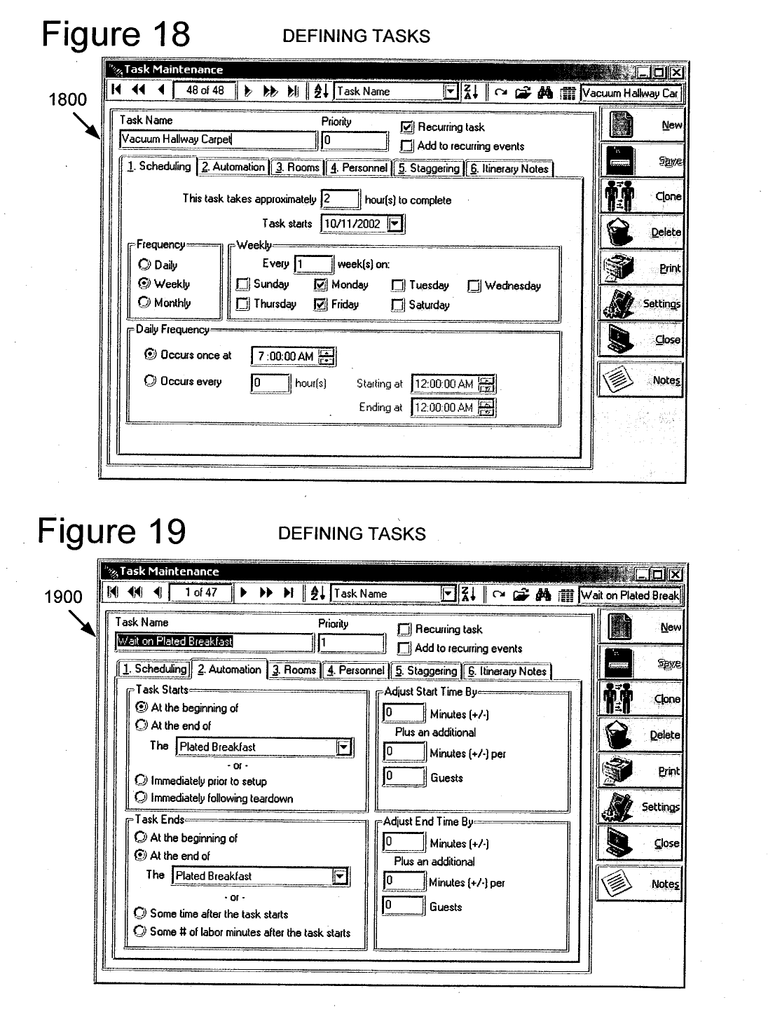

FIGS. 18-19 illustrate screen displays 1800, 1900 provided by the labor and resource scheduling system 210 for entry and display of data defining tasks at the facility. Recurring tasks can be create to handle maintenance and other actions. Event-specific tasks also can be created for automatically taking into account guest counts, location and facility specific service standards for use in the automatic scheduling procedures discussed above. The task definitions are typically configured at installation of the system for scheduling at a particular facility, and also can be later added to or edited.

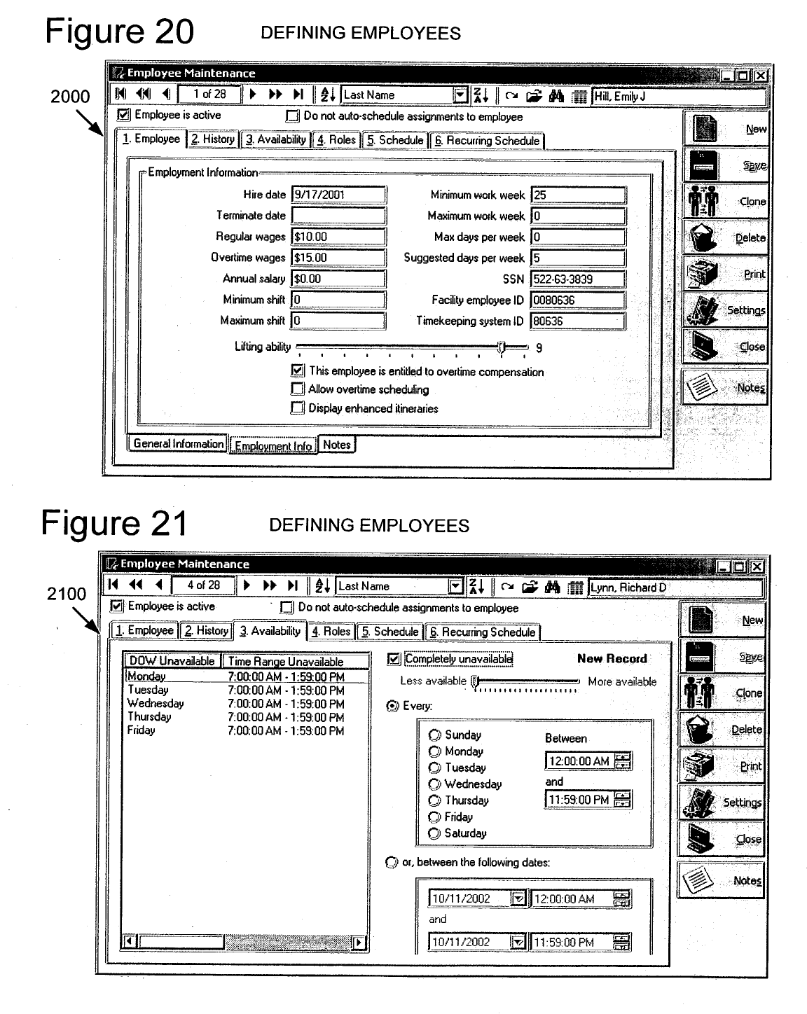

FIGS. 20-21 illustrate screen displays 2000, 2100 provided by the labor and resource scheduling system 210 for entry and display of data defining employees to be scheduled for events at the facility. The employee definition data includes name and address, allowed work hours, minimum and maximum work weeks and shifts, pay rates and more to assist in the automatic scheduling procedure discussed above, to select the appropriate employee for task assignments. These employee definitions are entered both at configuration and as changes arise during use of the system.

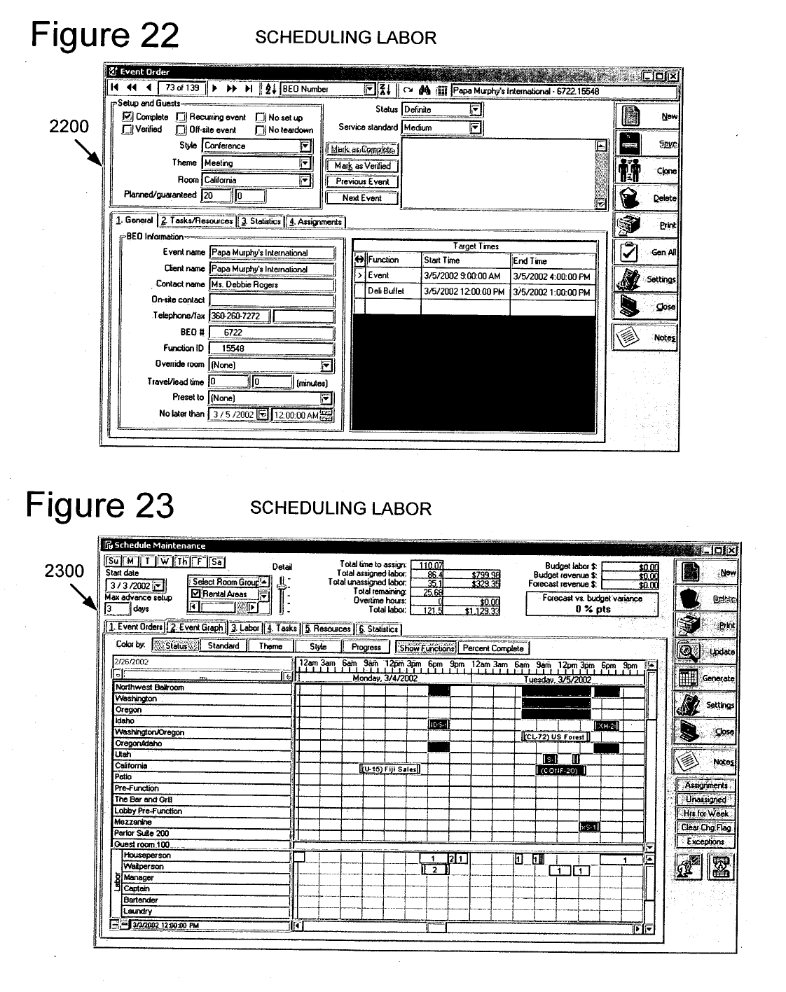

FIGS. 22 and 23 illustrate screen displays 2200, 2300 presented by the labor and resource scheduling system that are used during scheduling. As discussed above, the BEO information is imported from a facility's EMS data output, and also is reviewed and updated by the SM in the scheduling system 210 prior to automatic scheduling. Clicking the “generate” button on the schedule maintenance display 2300 initiates the automatic scheduling procedure discussed above to create an automated schedule, which is then available for supervisory review, input and change. The SM or other user also can choose to personally control assignment of itinerary using manual scheduling procedures, as also discussed above.

### Suitable Computing Environment

The above described processes in the labor and resource scheduling system can be performed on any of a variety of computing devices, including among other examples, computers; personal computers, laptops, handheld computers, server computers, mainframe computers, among others. The scheduling techniques can be implemented in hardware circuitry, as well as in software executing within a computer or other computing environment, such as shown in FIG. 24.

FIG. 24 illustrates a generalized example of a suitable computing environment (2400) in which described embodiments may be implemented. The computing environment (2400) is not intended to suggest any limitation as to scope of use or functionality of the invention, as the present invention may be implemented in diverse general-purpose or special-purpose computing environments.

With reference to FIG. 24, the computing environment (2400) includes at least one processing unit (2410) and memory (2420). In FIG. 24, this most basic configuration (2430) is included within a dashed line. The processing unit (2410) executes computer-executable instructions and may be a real or a virtual processor. In a multi-processing system, multiple processing units execute computer-executable instructions to increase processing power. The memory (2420) may be volatile memory (e.g., registers, cache, RAM), non-volatile memory (e.g., ROM, EEPROM, flash memory, etc.), or some combination of the two. The memory (2420) stores software (2480) implementing the described image and/or video encoder/decoder and transforms.

A computing environment may have additional features. For example, the computing environment (2400) includes storage (2440), one or more input devices (2450), one or more output devices (2460), and one or more communication connections (2470). An interconnection mechanism (not shown) such as a bus, controller, or network interconnects the components of the computing environment (2400). Typically, operating system software (not shown) provides an operating environment for other software executing in the computing environment (2400), and coordinates activities of the components of the computing environment (2400).

The storage (2440) may be removable or non-removable, and includes magnetic disks, magnetic tapes or cassettes, CD-ROMs, CD-RWs, DVDs, or any other medium which can be used to store information and which can be accessed within the computing environment (2400). The storage (2440) stores instructions for the software (2480) implementing the labor and resource scheduling for events.

The input device(s) (2450) may be a touch input device such as a keyboard, mouse, pen, or trackball, a voice input device, a scanning device, or another device that provides input to the computing environment (2400). For audio, the input device(s) (2450) may be a sound card or similar device that accepts audio input in analog or digital form, or a CD-ROM reader that provides audio samples to the computing environment. The output device(s) (2460) may be a display, printer, speaker, CD-writer, or another device that provides output from the computing environment (2400).

The communication connection(s) (2470) enable communication over a communication medium to another computing entity. The communication medium conveys information such as computer-executable instructions, compressed audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The scheduling techniques herein can be described in the general context of computer-readable media. Computer-readable media are any available media that can be accessed within a computing environment. By way of example, and not limitation, with the computing environment (2400), computer-readable media include memory (2420), storage (2440), communication media, and combinations of any of the above.

The scheduling techniques herein can be described in the general context of computer-executable instructions, such as those included in program modules, being executed in a computing environment on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing environment.

For the sake of presentation, the detailed description uses terms like “determine,” “generate,” “adjust,” and “apply” to describe computer operations in a computing environment. These terms are high-level abstractions for operations performed by a computer, and should not be confused with acts performed by a human being. The actual computer operations corresponding to these terms vary depending on implementation.

Having described and illustrated the principles of our invention with reference to described embodiments, it will be recognized that the described embodiments can be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiments shown in software may be implemented in hardware and vice versa.

In view of the many possible embodiments to which the principles of our invention may be applied, we claim as our invention all such embodiments as may come within the scope and spirit of the following claims and equivalents thereto.

We claim:

1. A computer-implemented method of automated scheduling of labor and resources, comprising:
producing a data set defining time parameters for resources and locations of the facility based upon a time and motion study analysis of the facility;
for a set of orders to be fulfilled utilizing the facility, determining a plurality of schedulable assignments for tasks using the resources to accomplish the orders, the schedulable assignments having times and durations determined based at least in part upon the time parameters defined in the data set; and
scheduling the schedulable assignments in a plurality of work shifts of employees of the facility during a work period.

2. The method of claim 1 wherein at least some of the time parameters parameterize time to move units of a set of resources between pairs of a set of locations in the facility.

3. The method of claim 1 wherein the data set further defines time parameters to perform tasks relating to the resources.

4. The method of claim 1 wherein the tasks relating to the resources comprise one or more of set-up, preparation, tear down, and cleaning the resources.

5. A computer readable data storage media having a labor and resource scheduling software program stored thereon executable on a computer system to perform a method of automated scheduling of labor and resources, the method comprising:
producing a data set defining time parameters for resources and locations of the facility based upon a time and motion study analysis of the facility;
for a set of orders to be fulfilled utilizing the facility, determining a plurality of schedulable assignments for tasks using the resources to accomplish the orders, the schedulable assignments having times and durations determined based at least in part upon the time parameters defined in the data set; and
scheduling the schedulable assignments in a plurality of work shifts of employees of the facility during a work period.

6. In a computer, a method of automated scheduling of labor and resources, comprising:
generating a data set defining timing parameters for a collection of locations and a collection of resources specific to a facility based on a time and distance study analysis of the facility, the timing parameters including at least timings to move a unit of the collection of resources between various pairings of the locations;
receiving input of a plurality of order units for work to be performed utilizing the resources and the locations in the facility;
generating a plurality of schedulable tasks for accomplishing the order units;
determining times and durations for the tasks based on the data set;
scheduling employees for a number of work shifts during a period sufficient to accomplish the tasks according to the determined times and durations;
assigning the tasks to the scheduled work shifts; and
presenting an employee itinerary report listing tasks assigned for the work shifts.

7. A computer implemented method of scheduling labor and resources to fulfill event orders for a facility, comprising:
configuring resource and location definition data sets having timing parameters for groups of resources and locations of the facility, the timing parameters including at least parameters defining time to move resources between various locations of the facility, and time to perform set-up, preparation, tear-down and/or cleaning of the respective resources;
receiving data input defining a plurality of orders for events at the facility;
selecting resources to be utilized for the events;
determining a plurality of tasks for utilizing the resources to fill the event orders, the tasks having times and durations based upon the timing parameters;
scheduling the tasks into work shifts according to the times and durations; and
producing a shift schedule report detailing tasks assigned to be performed for the shifts.

8. The method of claim 7 further comprising:
configuring an employees definition data set having data representing capabilities of the employees to perform tasks involving the resources; and
selecting employees for the work shifts according to the capabilities data.

9. The method of claim 8 wherein scheduling the tasks into work shifts further comprises:
configuring the employees definition data set to further have data representing availability of the employee;
determining a start time of a shift based upon at least some of the tasks having a common time frame; and
selecting an employee for the shift according to the determined start time and employees definition data set.

10. A computer readable storage media having a computer-executable software program stored thereon operable upon execution on a computer to perform a method of scheduling labor and resources to fulfill event orders for a facility, the method comprising:
configuring resource and location definition data sets having timing parameters for groups of resources and locations of the facility, the timing parameters including at least parameters defining time to move resources between various locations of the facility, and time to perform set-up, preparation, tear-down and/or cleaning of the respective resources;
receiving data input defining a plurality of orders for events at the facility;
selecting resources to be utilized for the events;
determining a plurality of tasks for utilizing the resources to fill the event orders, the tasks having times and durations based upon the timing parameters;
scheduling the tasks into work shifts according to the times and durations; and
producing a shift schedule report detailing tasks assigned to be performed for the shifts.

11. A computer implemented method of assigning shifts and tasks to employees, the method comprising:
configuring a data set representing results from a time and motion study of resources and areas to be utilized in fulfilling orders at a facility;
receiving data defining a set of orders to be filled within a period of time at the facility;
determining a set of tasks to provide the resources for fulfilling the defined orders with time constraints based upon the data set; and
scheduling the tasks into a plurality of shifts of employees to meet the time constraints.

12. The method of claim 11 wherein the orders comprise an order to service an event at a designated area of the facility, and wherein the data set comprising time parameters indicative of time to move units of the resources between combinations of the areas of the facility.

13. The method of claim 12 wherein determining the set of tasks comprises:
determining a set of trips between areas to provide the resources for the event at the designated area in the facility; and
calculating as a time constraint, times to provide the resources for the event at the designated area based on the determined trips and time parameters of the configured data set.

14. The method of claim 12 wherein the data set further comprises time parameters indicative of time for set-up, preparation, tear down and cleaning of units of the resources.

15. The method of claim 14 wherein determining the set of tasks comprises:
calculating a number of units of the resources required to fulfill the event orders; and
calculating time of tasks to set-up, prepare, tear down and clean the calculated number of resources based upon the time parameters.

16. The method of claim 15 wherein determining the set of tasks further comprises:
determining a set of trips between areas for the tasks; and
calculating the time of tasks to set-up, prepare, tear down and clean the calculated number of resources further based upon the determined trips and time parameters of the configured data set.

17. The method of claim 11 wherein receiving the data defining a set of orders comprises import of data from an event booking system.

18. The method of claim 11 wherein receiving the data defining a set of orders comprises manual input of the data.

19. The method of claim 11 wherein determining the set of tasks comprises calculating a number of units of the resources required to fulfill the event orders.

20. The method of claim 11 further comprising adjusting the time constraints of the tasks by a pad factor to account for reasonable delays.

21. The method of claim 11 further comprising adjusting the time constraints of the tasks by a hustle factor for tasks designated as subject to a quick set constraint.

22. A computer readable storage medium having stored thereon a computer-executable-program operating upon execution on a computer to perform a method of assigning shifts and tasks to employees, the method comprising:
configuring a data set representing results from a time and motion study of resources and areas to be utilized in fulfilling orders at a facility;
receiving data defining a set of orders to be filled within a period of time at the facility;
determining a set of tasks to provide the resources for fulfilling the defined orders with time constraints based upon the data set; and
scheduling the tasks into a plurality of shifts of employees to meet the time constraints.

23. The computer readable storage medium of claim 22 wherein the orders comprise an order to service an event at a designated area of the facility, and wherein the data set comprising time parameters indicative of time to move units of the resources between combinations of the areas of the facility.

24. The computer readable storage medium of claim 23 wherein determining the set of tasks comprises:
determining a set of trips between areas to provide the resources for the event at the designated area in the facility; and
calculating as a time constraint, times to provide the resources for the event at the designated area based on the determined trips and time parameters of the configured data set.

25. The computer readable storage medium of claim 22 wherein the data set further comprises time parameters indicative of time for set-up, preparation, tear down and cleaning of units of the resources.

26. The computer readable storage medium of claim 25 wherein determining the set of tasks comprises:
calculating a number of units of the resources required to fulfill the event orders; and
calculating time of tasks to set-up, prepare, tear down and clean the calculated number of resources based upon the time parameters.

27. The computer readable storage medium of claim 26 wherein determining the set of tasks further comprises:
determining a set of trips between areas for the tasks; and
calculating the time of tasks to set-up, prepare, tear down and clean the calculated number of resources further based upon the determined trips and time parameters of the configured data set.

28. A computer-implemented method of assigning shifts of tasks including service and set-up and tear down of resources to employees, comprising:
producing a data set representing results of a time and motion study for service tasks and setup/teardown of resources performed at a facility;
receiving input of orders for events to be scheduled at the facility during a period;
determining schedulable assignments based upon scheduled events and timing of service tasks and setup/teardown of resources based on the time and motion study results data set;
selecting one or more employees to perform the schedulable assignments; and
assigning the assignments and the employees to shifts.

29. The method of claim 28, wherein determining schedulable assignments comprises calculating number of resources required for the events.

30. The method of claim 28, wherein determining schedulable assignments further comprises calculating time of schedulable assignments to move, setup, clean and teardown said resources based on the time and motion study results represented in the data set.

31. The method of claim 30, wherein calculating time of schedulable assignments to move, setup, clean and teardown resources comprises determining a number of trips and departure and destination areas of the trips.

32. The method of claim 30, wherein calculating time of schedulable assignments to move, setup, clean and teardown resources further comprises determining distance between the departure and destination areas of the trips.

33. The method of claim 30, further comprising:
designating whether the schedulable assignments are to be quick set, and
wherein calculating time of the schedulable assignments further comprises accumulating a total time of the schedulable assignments, then adjusting by one of a variable padding factor to account for reasonable delays if designated not to be quick set, and a variable hustle factor if designated to be quick set.

34. The method of claim 28, wherein determining schedulable assignments also comprises calculating a number of employees, start time and duration of service tasks for the events.

35. The method of claim 28, wherein assigning the assignments and employees to shifts comprises:
creating a shift of a preset duration;
sequentially assigning assignments to fill the shift, skipping breaks when possible, until the entire shift has been filled or there are no assignments available to be assigning during the shift; and
if any unfilled time exists at the beginning or end of the shift, compressing the shift to remove unfilled time.

36. The method of claim 35, wherein assigning assignments and employees to shifts comprises:
prioritizing assignments;
determining best time to assign assignment with the highest priority and scheduling such assignment for the longest duration possible, up to the duration of the assignment; and
repeating the prioritization, determining and scheduling until all assignments are assigned or the shift is full.

37. The method of claim 36, wherein prioritizing assignments comprises calculating weight by determining at least one of:
a proximity of the event to any events currently assigned during the shift;
a length of time before the event starts, ensuring those assignments with the shortest window of opportunity are assigned first;
whether any assignments already assigned to the shift are of the same event; and
a skill level and lifting ability required to complete the assignment.

38. A computer implemented method of providing clearer directions through the use of printed reports for employees in setting up, tearing down, or servicing events at a facility, the method comprising:
receiving results from a time and motion study for service tasks and setup/teardown of resources performed at the facility;
receiving a list of events scheduled at the facility;
determining schedulable assignments based upon scheduled events and timing of service tasks and setup/teardown of resources;
selecting employees for the assignments; and
printing at least one report having information designating the assignments for the employees, including required actions and time for completion for the assignments.

39. A computer implemented method of reducing labor costs for event hosting, the method comprising:
receiving results from a time and motion study for service tasks and setup/teardown of resources performed at a facility;
receiving a list of events scheduled at the facility;
determining schedulable assignments based upon scheduled events and time to perform the service tasks and setup/teardown of resources based on the results;
scheduling employees to perform the assignments;
performing at least one labor cost optimization of the schedule to reduce overall event labor costs;
determining a performance measure of the labor costs of the events; and
producing a report indicating the performance measure.

40. The method of claim 39, wherein performing the at least one labor cost optimization comprises assigning tasks to minimize an overall number of employees and duration of shifts.

41. The method of claim 39, wherein performing the at least one labor cost optimization comprises scheduling the tasks and shifts with consideration of employee wages.

42. The method of claim 39, wherein performing the at least one labor cost optimization comprises comparing scheduled wages against last year's wages for the same period.

43. The method of claim 39, wherein reducing overall event labor costs further comprises comparing scheduled wages against the facility's budgeted wages for the same period.
